(19) United States
(12) Patent Application Publication
(10) Pub. No.: US 2005/0072613 A1
(43) Pub. Date: Apr. 7, 2005

(54) Suspension assembly

(76) Inventors: Hugues Maltais, Ste-Anne De La Rochelle (CA); Bethold Fecteau, Richmond (CA); Benolt Marleau, Saint-Anleet (CA)

Correspondence Address: BOMBARDIER RECREATIONAL PRODUCTS INC;INTELLECTUAL PROPERTY DEPT, PO BOX 230, NORTON, VT, 05907-0230, US

(21) Appl. No.: 10/422,820

(22) Filed: Apr. 25, 2003

Related U.S. Application Data
(60) Provisional application No. 60/375,402, filed on Apr. 26, 2002.

(51) Int. Cl. B62M 27/02

(52) U.S. Cl. 180/182

(57) ABSTRACT

A generally tubular vehicle frame assembly includes a tunnel, an engine support, a forward support assembly, a suspension arm pivot base assembly, and a rear brace assembly. The forward support assembly, suspension arm pivot base assembly, and engine support generally form a triangular shape as viewed from the side. The tubular construction of the frame assembly enables the same forward support assembly, suspension arm pivot base assembly, suspension system, and steering system to be used with variously sized tunnels by switching just several tubular components of the frame assembly. Left and right lower suspension arms are pivotally connected to the suspension arm pivot base assembly for independent pivotal movement relative to the frame assembly about a common pivotal axis. The left and right lower suspension arms being constructed such that the same suspension arm can be used on either the right side or the left side of the vehicle without modifying the pivot point of the ski.

### CROSS-REFERENCE

This application claims priority to U.S. Application No. 60/375,402, filed Apr. 26, 2002, entitled “FRAME CONSTRUCTION FOR A VEHICLE,” the entire contents of which are incorporated herein by reference.

### 1. FIELD OF THE INVENTION

The present invention relates to the construction of vehicles such as snowmobiles, all terrain vehicles (“ATVs”), and other similar vehicles. More specifically, the present invention concerns the construction of a frame and related structural elements that enhance the ruggedness and ability of such vehicles to operate across a wide variety of different terrains and under a wide variety of conditions. In addition, the present invention concerns the design and construction of a frame for snowmobiles, ATVs, and related vehicles that facilitate the construction of such vehicles with an improved rider positioning.

### 2. DESCRIPTION OF RELATED ART AND GENERAL BACKGROUND

Snowmobiles, ATVs, and related vehicles (hereinafter, “recreational vehicles,” although the appellation should not be construed to be limited only to the vehicles or type of vehicles described herein) often function under similar operating conditions. Despite this, snowmobiles, ATVs, and other recreational vehicles often do not share a common design approach or a commonality of components. This is due, in large part, to the different stresses and strains (mainly at the extremes) that the different vehicles experience during routine operation.

Specifically, snowmobiles are designed with frame assemblies and suspensions that easily absorb the shock of obstacles encountered on groomed trails and in deep snow. They are also designed to handle the forces generated when the snowmobile is driven aggressively (e.g., under racing conditions). In addition, their frame assemblies are designed to provide optimum steering and performance in snow, whether on groomed snowmobile trails (packed snow) or in ungroomed, off-trail areas (powder or natural snow).

ATVs, on the other hand, are designed with suspensions and frame assemblies that are expected to absorb the type of momentarily intense forces associated with more rugged terrain, specifically of the type encountered in forests and woodland environments. In addition, an ATV frame is designed to withstand forces associated with significant torsional stresses that are typical when an ATV straddles large objects or when the wheels are disposed at different elevations because of the extreme terrain in which the ATV often operates.

It should be kept in mind that the design parameters of the frame assemblies for these two vehicles are also different. In a snowmobile, the frame at the rear of the vehicle is only about 15 inches wide. This is sufficient to cover the endless track that propels the vehicle and to provide a seating area for the driver. The narrow width, however, imposes certain design restrictions on the vehicle. ATVs, on the other hand, are designed with a significantly wider base, which is typically 50 inches or more. This width also imposes certain design restrictions on the ATV.

Snowmobiles and ATVs are also designed with different centers of gravity. In the typical snowmobile, the center of gravity is very low. This assists the snowmobile rider when he or she is on a slope or in a turn because the snowmobile will naturally resist the tendency to lean or tip. ATVs, on the other hand, like off-road trucks and the like, are expected to traverse taller objects. Accordingly, their frames are designed so that the engine and seating area is further from the ground than a snowmobile. Thus, ATVs have higher centers of gravity.

Naturally, since both vehicles are designed with off-road use in mind, there are similarities between the two. Both are provided with rugged frames. Moreover, both are provided with strong suspensions. Despite this, there have been few vehicles designed that capitalize on these similarities.

Recognizing this basic similarity between the two vehicles, some after-market designers have developed kits that permit snowmobiles to be converted to ATVs and vice-versa. However, such kits are limited in their effectiveness because the two vehicles are so completely different from one another in their basic designs. The resulting, converted vehicles suffer from drawbacks that are associated with the purpose for which the primary vehicle was designed. For example, a snowmobile converted to an ATV is not expected to be able to traverse the same type of terrain as a pure ATV. Similarly, an ATV that has been converted to a snowmobile is not expected to be able to traverse the same terrain that a pure snowmobile can.

Partly due to the consumer's use of snowmobiles in the winter and ATVs in the summer, the evolution of both snowmobiles and ATVs has converged in recent years. Also, in recent years, designers have begun to apply the same basic design concepts to both vehicle types. What has resulted is a recognition that vehicles may be designed that incorporate many of the same structural elements and follow very similar design approaches.

The basis for the present invention stems from this basic recognition.

### SUMMARY OF THE INVENTION

It is, therefore, an object of the present invention to provide a frame assembly with a tunnel, an engine cradle disposed forward of the tunnel and connected thereto, and a sub-frame disposed forward of the engine cradle and connected thereto. The frame assembly further includes a forward support assembly extending upwardly from the subframe, an upper column extending upwardly from the engine cradle to connect with the forward support assembly, and a rear brace assembly extending upwardly from the tunnel to connect with the forward support assembly and the upper column.

It is another object of the present invention to provide a frame assembly wherein the forward support assembly, the upper column, and the rear brace assembly connect at an apex above the upper column.

Another object of the present invention is to provide a frame assembly where the forward support assembly and the rear brace assembly form a pyramidal construction.

A further object of the present invention is to provide a frame assembly further including a steering bracket connected at the apex for supporting a steering shaft at its upper end. In an alternate embodiment, the steering bracket may include a plurality of pairs of holes for positioning of the steering shaft in a plurality of positions.

One other object of the present invention is to provide a frame assembly that also includes an engine disposed in the engine cradle and an endless track operatively connected to the engine and disposed beneath the tunnel for propulsion. In this embodiment, a pair of skis are operatively connected to a steering device for steering.

Still another object of the present invention is to provide a frame assembly with an engine disposed in the engine cradle and a rear wheel operatively connected to the engine and disposed beneath the tunnel for propulsion. In this embodiment, two front wheels operatively connected to a steering device for steering.

It is yet another object of the present invention to provide a frame assembly for a vehicle that includes a tunnel and an engine cradle adapted to receive an engine therein. A rear brace assembly is attached to the tunnel at a point between its front and rear ends and extends upwardly therefrom. A forward support assembly is attached to the rear brace assembly and extends forwardly and downwardly therefrom. In a further variation of this frame assembly, the rear brace assembly comprises a left and a right leg and the forward support assembly comprises a left and a right leg. The left and right legs of the rear brace assembly and the forward support assembly connect to one another at an apex to form a pyramidal structure above the tunnel and engine cradle.

A further object of the present invention is to provide a generally tubular frame assembly for a vehicle.

A further object of the present invention is to provide a forward support assembly, suspension arm pivot base, front suspension system, and steering system that can be used with tunnels of different sizes corresponding to different width endless tracks.

A further object of the present invention is to provide a vehicle having a tunnel. An engine support has first and second legs spaced apart from each other. The first and second legs each include forward and rearward portions. The rearward portions of the first and second legs are connected to the tunnel. An upwardly-extending forward support assembly includes third and fourth legs that each have a lower end, an intermediate portion, and an upper end. The forward portion of the first leg is connected to the intermediate portion of the third leg at a first connection point. The forward portion of the second leg is connected to the intermediate portion of the fourth leg at a second connection point.

According to a further aspect of the present invention, the upper and lower ends of the third leg are connected to the upper and lower ends, respectively, of the fourth leg. The intermediate portions of the third and fourth legs are laterally spaced from each other such that the forward support assembly generally forms a diamond shape. A cross-member may be connected between the intermediate portions of the third and fourth legs so as to divide the diamond shape into upper and lower triangles.

A further object of the present invention is to provide a vehicle having a frame assembly. A first right suspension arm includes first and second portions, the first portion of the first right suspension arm being connected to the frame assembly for pivotal movement relative to the frame assembly about a first axis. A first left suspension arm includes first and second portions, the first portion of the first left suspension arm being connected to the frame assembly for pivotal movement relative to the frame assembly about the first axis. A right steered device is connected to the second portion of the first right suspension arm. A left steered device is connected to the second portion of the first left suspension arm. The first axis is parallel to a vertically and longitudinally extending center plane of the vehicle.

Yet a further object of the present invention is to provide a suspension arm having first and second portions such that the suspension arm can connect to one of the left side and the right side of the vehicle while having the second portion remain at the same longitudinal position.

According to a further object of the present invention a suspension arm geometry is provided such that two identical suspension arms can be used on opposing sides of the vehicle while maintaining a zero offset between the lateral ends of opposing suspension arms.

Additional and/or alternative objects of the present invention will be made apparent by the discussion that follows.

### BRIEF DESCRIPTION OF THE DRAWINGS

The invention will be more fully described in conjunction with the following drawings wherein:

FIG. 1 is a side-view schematic illustration of a prior art snowmobile, showing the prior art positioning of a rider thereon;

FIG. 2 is a side view illustration of the exterior of a snowmobile constructed according to the teachings of the present invention, also showing the positioning of a rider thereon;

FIG. 3 is an overlay comparison between the a prior art snowmobile (of the type depicted in FIG. 1) and a snowmobile constructed according to the teachings of the present invention (as shown in FIG. 2), illustrating the difference in passenger positioning, among other features;

FIG. 4 is an exploded view of a frame assembly representative of the type of construction typical of a snowmobile assembled according to the teachings of the prior art (specifically, the view illustrates the components of a 2000 model year Ski-Doo® Mach™ Z made by Bombardier Inc. of Montreal, Quebec, Canada);

FIG. 5 is a side view schematic illustration of the snowmobile illustrated in FIG. 2, with the fairings and external details removed to show some of the internal components of the snowmobile and their positional relationship to one another;

FIG. 6 is a perspective illustration of a portion of the frame assembly of the present invention, specifically the portion disposed toward the rear of the vehicle;

FIG. 7 is a perspective illustration of a forward support frame, which connects with the portion of the frame assembly depicted in FIG. 6;

FIG. 8 is a front view illustration of an upper column of the frame assembly shown in FIG. 6;

FIG. 9 is a left side view illustration of the upper column depicted in FIG. 8;

FIG. 10 is a right side view illustration of the upper column shown in FIG. 8;

FIG. 11 is a perspective illustration, from the front left side, of a tunnel portion of the frame assembly of the present invention;

FIG. 12 is another perspective illustration, from the rear left side, of the tunnel portion of the present invention shown in FIG. 11;

FIG. 13 is a perspective illustration, from the front left side, showing the combination of the frame assembly depicted in FIG. 6 connected to the tunnel portion depicted in FIGS. 11 and 12;

FIG. 14 is a perspective illustration, from the rear left side, showing the combination of the frame assembly depicted in FIG. 6 connected to the tunnel portion depicted in FIGS. 11 and 12 and also showing a portion of a front suspension assembly;

FIG. 15 is a perspective illustration, from the front left side, of some of the components that are part of the front suspension assembly depicted in FIG. 14;

FIG. 16 is a perspective illustration, from the front left side, of a portion of a sub-frame that is part of the front suspension assembly illustrated in FIG. 15;

FIG. 17 is another perspective illustration, from the front left side, of the front suspension assembly for a snowmobile, constructed according to the teachings of the present invention, showing the positional relationship between the parts illustrated in FIG. 15 and the sub-frame illustrated in FIG. 16;

FIG. 18 is a side view schematic of the frame assembly of the present invention showing the positional relationship between the frame assembly and the engine, among other components;

FIG. 19 is a perspective illustration, from the left side, of the frame assembly according to the teachings of the present invention, also showing the positional relationship between the frame assembly, the engine, and the front suspension;

FIG. 20 is another perspective illustration, from the front left side, of the combined frame assembly and tunnel portion constructed according to the teachings of the present invention, also showing the positional relationship between the frame assembly, the engine, and the front suspension;

FIG. 21 is a front perspective illustration of the embodiment depicted in FIG. 20;

FIG. 22 is a perspective illustration of a slightly different embodiment from the one depicted in FIG. 20;

FIG. 23 is a schematic side view illustration of the frame assembly of the present invention as embodied in a wheeled vehicle;

FIG. 24 is a schematic side view illustration of the frame assembly of the present invention as embodied in a slightly modified version of a wheeled vehicle;

FIG. 25 is an enlarged side view illustration of the frame assembly of the present invention as embodied in the wheeled vehicle shown in FIG. 24;

FIG. 26 is a perspective illustration, from the left rear, of the frame assembly of the present invention, showing some of the detail of the front suspension incorporated into the wheeled vehicle shown in FIGS. 23 and 24;

FIG. 27 is a perspective illustration, from the front left, showing the frame assembly of the present invention as depicted in FIG. 26;

FIG. 28 is a perspective illustration, from the rear left side of an alternate embodiment of the frame assembly of the present invention;

FIG. 29 is a side view illustration of the frame assembly shown in FIG. 28;

FIG. 30 is a top view of the frame assembly depicted in FIG. 28;

FIG. 31 is a side view illustration of the frame assembly shown in FIG. 29, illustrating the variable positioning of the handlebars that is possible with this embodiment of the present invention;

FIG. 32 is a perspective illustration of the embodiment shown in FIG. 31, showing in greater detail the variations in positioning of the handlebars that is made possible by the construction of the present invention;

FIG. 33 is a close-up side-view detail of the connection point between the handlebars and the frame assembly of the present invention, illustrating the variable positioning of the handlebars;

FIG. 34 is a further illustration of the variable positioning feature of the present invention;

FIG. 35 is a graph showing the vertical displacement rate of the frame of the present invention in comparison with a prior art Bombardier snowmobile (the ZX™ series) and a prior art snowmobile made by Arctic Cat;

FIG. 36 is a perspective illustration, taken from the rear left side, of an alternate embodiment of the frame assembly of the present invention;

FIG. 37 is a top view of the frame assembly shown in FIG. 36;

FIG. 38 is a partial top view of the frame assembly shown in FIG. 36;

FIG. 39 is a partial left side view of the frame assembly shown in FIG. 36;

FIG. 40 is a partial perspective view, taken from the lower right front side, of the frame assembly shown in FIG. 36;

FIG. 41 is a top view of an alternative embodiment of right and left lower suspension arms;

FIG. 42 is a perspective view of the right and left lower suspension arms of FIG. 41; and

FIG. 43 is a top view of an alternative embodiment of the right and left lower suspension arms.

### DESCRIPTION OF THE PREFERRED EMBODIMENTS

Before delving into the specific details of the present invention, it should be noted that the conventions “left,” “right,” “front,” and “rear” are defined according to the normal, forward travel direction of the vehicle being discussed. As a result, the “left” side of a snowmobile is the same as the left side of the rider seated in a forward-facing position on the vehicle (or travelling in a forward direction on the vehicle).

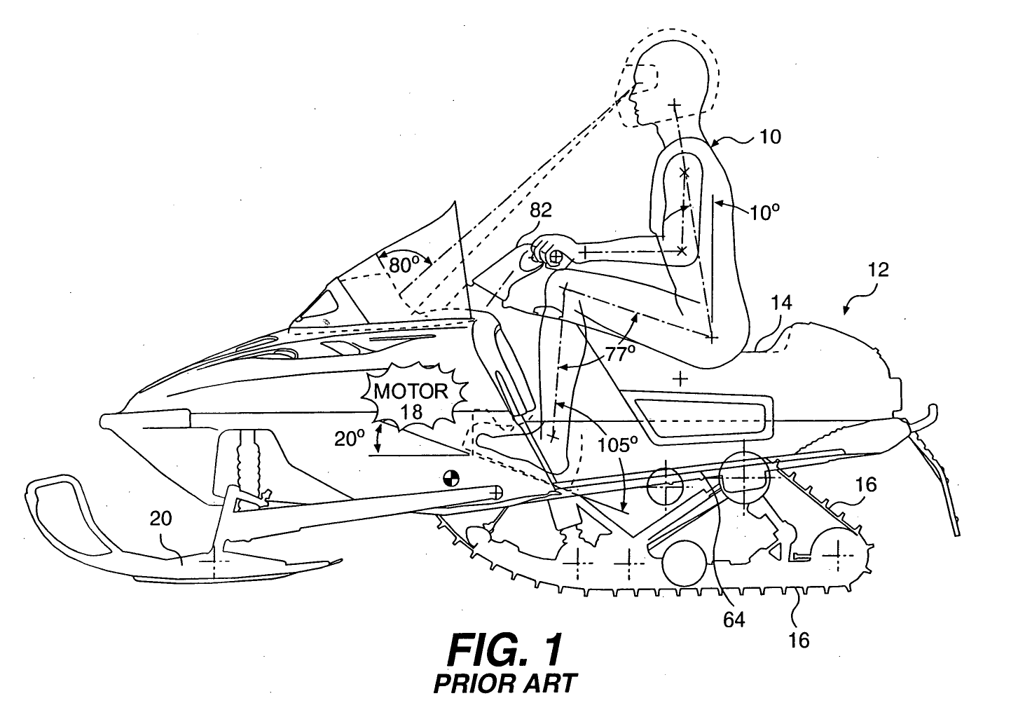

FIG. 1 illustrates a rider operator 10 sitting on a prior art snowmobile 12. Rider 10 is positioned on seat 14, with his weight distributed over endless track 16. Motor 18 (shown in general detail) is located over skis 20. As with any snowmobile, endless track 16 is operatively connected to motor (or engine) 18 to propel snowmobile 12 over the snow. Motor or engine 18 typically is a two-stroke internal combustion engine. Alternatively, a 4-stroke internal combustion engine may be substituted therefor. In addition, any suitable engine may be substituted therefor.

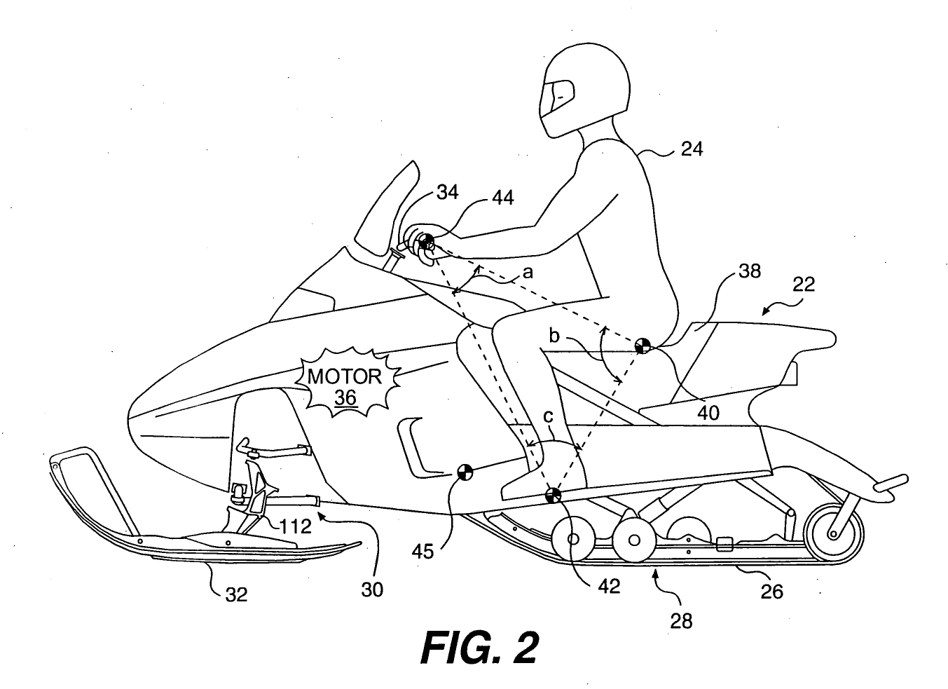

FIG. 2 provides a side view of a snowmobile 22 constructed according to the teachings of the present invention. Here, rider/operator 24 is shown in a more forward, motor cross racing-like position, which is one of the aspects of the present invention. In this position, the weight of operator 24 is forward of the position of rider 10 in the prior art example.

The positioning of rider 24 closer to motor 36 offers several advantages that are not achieved by the prior art. For example, since rider 24 is positioned closer to the engine 36, the center of gravity of rider 24 is closer to the center of gravity of the vehicle, which is often at the drive axle of the vehicle or near thereto. In other words, rider 24 has his weight distributed more evenly over the center of gravity of the vehicle. As a result, when the vehicle traverses rough terrain, rider 24 is better positioned so that he does not experience the same impact from an obstacle as rider 10 on snowmobile 12. The improved rider positioning illustrated in FIG. 2 also improves the rider's ability to handle the vehicle.

FIG. 2 illustrates the basic elements of snowmobile 22. Snowmobile 22 includes an endless track 26 at its rear for propulsion. A rear suspension 28 connects endless track 26 to the vehicle frame. Snowmobile 22 also includes a front suspension 30. Skis 32, which are operatively connected to handlebars 34, are suspended from the front suspension 30 for steering the vehicle. A motor or engine (preferably, an internal combustion engine) 36 is located at the front of snowmobile 22, above skis 32. Operator 24 is seated on a seat 38, which is positioned above the endless track 26.

Three positional points of particular relevance to the present invention are also shown in FIG. 2. Specifically, seat position 40, foot position 42, and hand position 44 of operator 24 are shown. In the modified seating position of operator 24, which is made possible by the teachings of the present invention, hand position 44 is forward of foot position 42, which is forward of seat position 40. The three positions define three angles, a, b, and c between them that help to define the seating position of operator 24, which permits rider 24 to be closer to center of gravity 45 of the vehicle. Moreover, hand position 44 is forward of center of gravity 45 of snowmobile 22.

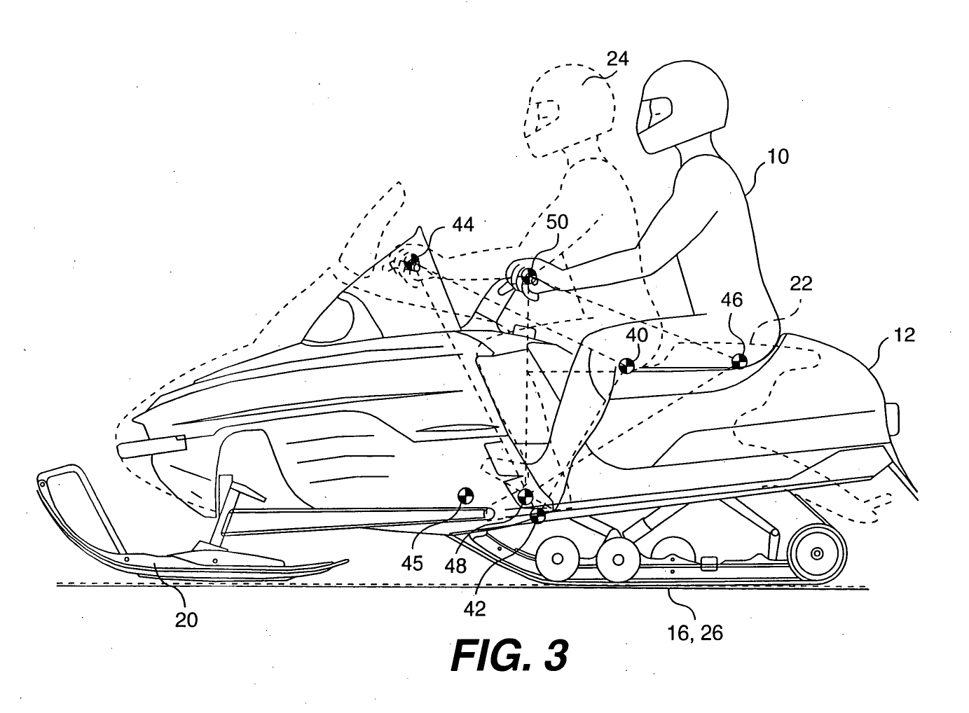

FIG. 3 provides an overlay between prior art snowmobile 12 and snowmobile 22 constructed according to the teachings of the present invention. Rider 10 (of prior art snowmobile 12) is shown in solid lines while operator 24 (of snowmobile 22) is shown in dotted lines for comparison. The comparative body positions of rider 10 and operator 24 are shown. As is apparent, the present invention permits the construction of a snowmobile 22 where the rider 24 is in a more forward position. Moreover seat position 40, foot position 42, and hand position 44 differ considerably from seat position 46, foot position 48, and hand position 50 in the prior art snowmobile 12. In this position, the center of gravity of operator 24 is closer to center of gravity 45 of snowmobile 22 than in the prior art example.

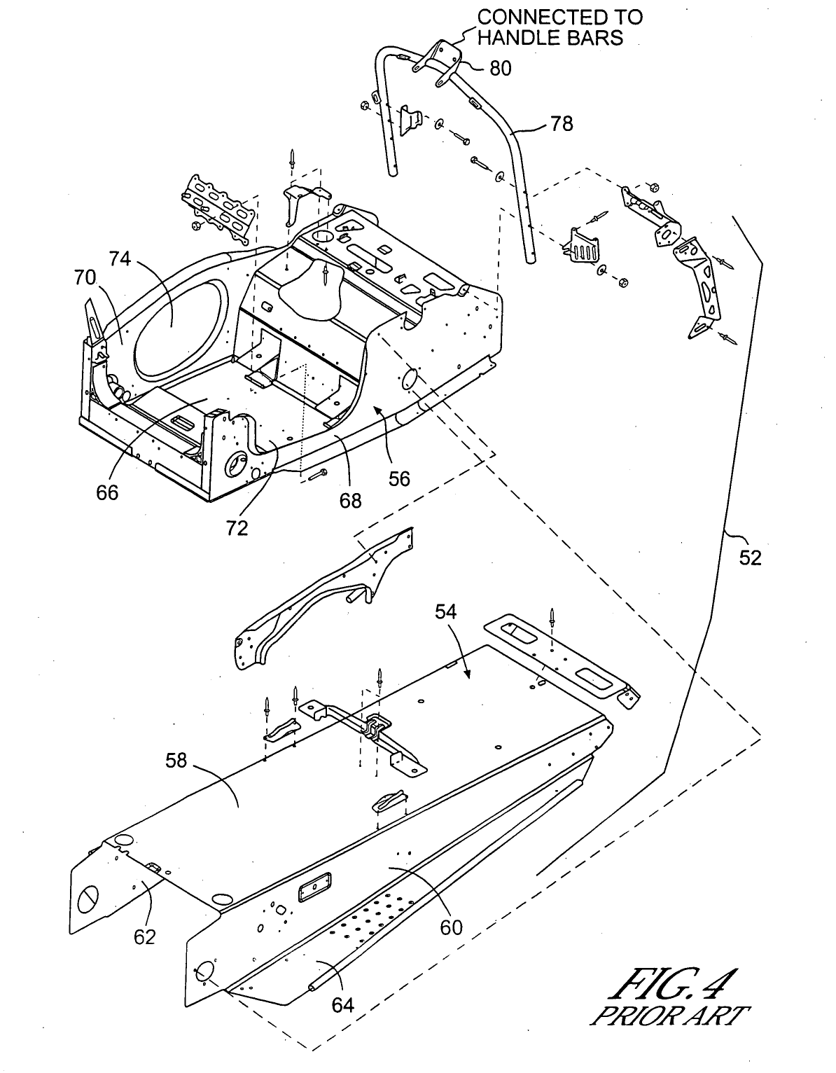

As a basis for comparison with the figures that provide the details of the present invention, FIG. 4 provides an exploded view of a frame assembly 52 for a snowmobile constructed according to the teachings of the prior art. Frame assembly 52 includes, as its major components, a tunnel 54 and an engine cradle 56. As illustrated, engine cradle 56 is positioned in front of tunnel 54. Engine cradle 56 receives motor 18.

As shown in FIG. 4, tunnel 54 is basically an inverted U-shaped structure with a top plate 58 integrally formed with left and right side plates 60, 62, respectively. Top plate 58 provides the surface onto with seat 14 is mounted, as would be known to those skilled in the art. Foot boards 64 (of which only the left foot board is visible in FIG. 4) are integrally formed with the side plates 60, 62 and extend outwardly, perpendicular to the plane of side plates 60, 62. Foot boards 64 provide a location on which rider 10 may place his feet during operation of snowmobile 12. While top plate 58, side plates 60, 62, and foot boards 64 are preferably formed from aluminum, any suitable alternative material may be used, as would be recognized by those skilled in the art. Moreover, while top plate 58, side plates 60, 62 and footboards 64 are shown as an integral structure, an integral construction is not required. Instead, top plate 58, side plates 60, 62, and foot boards 64 may be separately manufactured and connected to one another by any suitable means known in the art.

FIG. 4 also shows that engine cradle 56 is connected to tunnel 54 by any suitable means known to those skilled in the art. For example, engine cradle 56 may be welded or bolted to tunnel 54. Engine cradle includes a bottom plate 66 and left and right side walls 68, 70, which are provided with left and right openings 72, 74, respectively. Left opening 72 is provided so that the shafts for the transmission (typically a continuously variable transmission or CVT) may extend outwardly from left wall 68. The shafts that connect the engine 18 to the transmission pass through left opening 72. A gearbox (not shown) typically is provided on the right side of snowmobile 10. The shafts that connect engine 18 to the gearbox pass through right opening 74. Left and right openings 72, 74 also allow heat from engine 18 to be radiated from engine cradle 56, which assists in cooling engine 18.

As FIG. 4 illustrates, left side wall 68 is provided with a beam 76 that is removably connected thereto. Beam 76 may be removed during servicing, for example, to facilitate access to the engine components and peripheral elements disposed within left opening 72.

FIG. 4 also illustrates the placement of a handlebar support element 78, which connects to the rear of engine cradle 56. Handlebar support element 78 is generally an inverted U-shaped structure that extends upwardly from the combined engine cradle 56 and tunnel 54. A bracket 80 is positioned at the midpoint of handlebar support element 78 and provides structural support for handlebars 82, which is used to steer snowmobile 12.

To provide an improved driver positioning, as described above, the inventors of the present invention appreciated the advantages of moving handlebars 82 forward of the position shown in FIG. 1. To do this, however, required a novel approach to the construction of frame assembly 52 of snowmobile 12. The redesign resulted in the present invention, which is described in detail below.

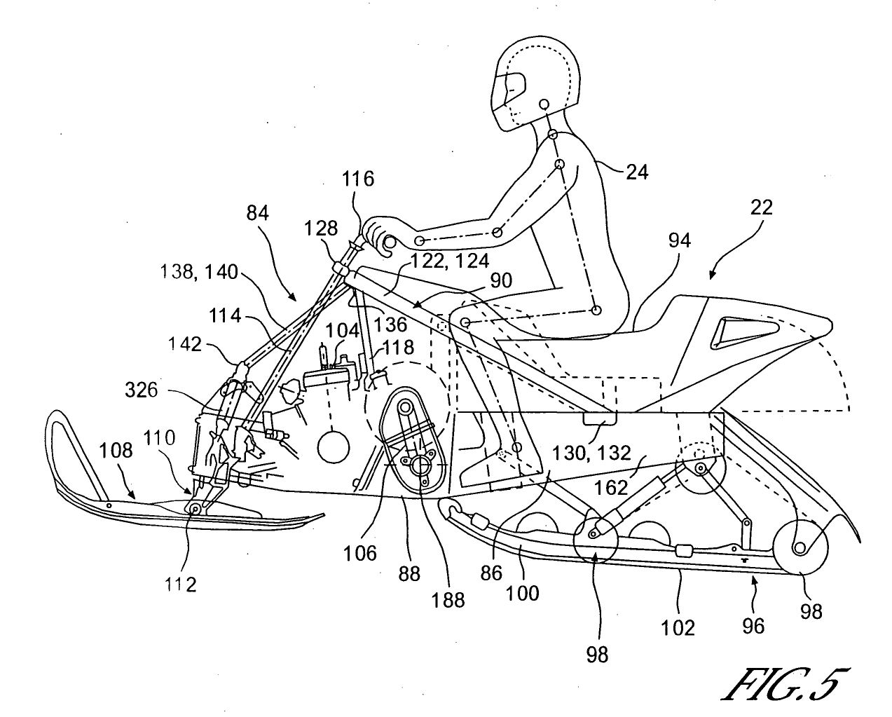

As illustrated in FIG. 5, snowmobile 22 incorporates a completely redesigned frame assembly 84. Frame assembly 84 includes, among other elements, tunnel 86, engine cradle 88, and over-arching frame elements 90. As with snowmobile 12, snowmobile 22 includes a seat 94 on which rider 24 sits while operating snowmobile 22. Tunnel 86 is connected to a rear suspension 96 that contains a number of wheels 98 disposed on a slide frame 100 around which an endless track 102 rotates to propel snowmobile 22 across the snow.

Endless track 102 is connected to engine 104 (preferably a two or four stroke internal combustion engine) positioned within engine cradle 88. Endless track 102 is connected to engine 104 through a transmission 106, which is preferably a continuously variable transmission (or “CVT”), as is known in the art.

Two skis 108 are provided at the front of snowmobile 22 for steering. Skis 108 are connected to engine cradle 88 through a front suspension 110. Front suspension 110 connects to skis 108 through a pivot joint 112 on the top of skis 108. Skis 108 are operatively connected to a steering shaft 114 that extends over engine 104. Steering shaft 114 is connected, in turn, to handlebars 116, which are used by operator 24 to steer snowmobile 22.

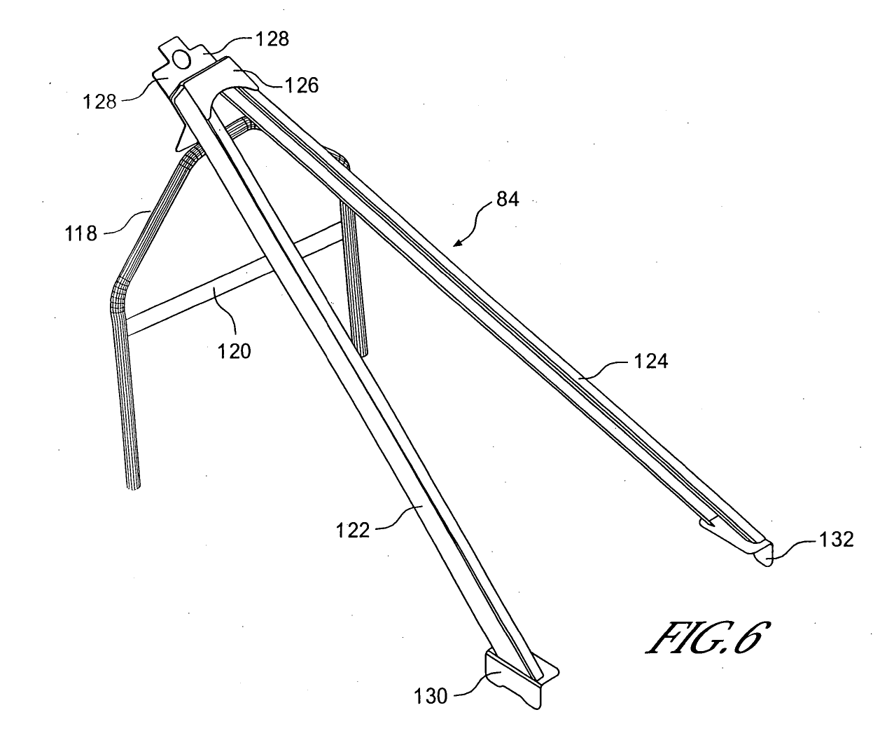

FIG. 6 illustrates the individual elements of rear frame assembly 84 in greater detail. Rear frame assembly 84 includes an upper column 118, which is an inverted U-shaped structural element. If necessary, upper column 118 may be reinforced with a cross-member 120, but this is not needed to practice the present invention. A left brace 122 and a right brace 124 are connected to a bracket 126 above upper column 118. A bushing or bearing (or other similar element) 128 is attached to bracket 126 and accepts steering shaft 114 therethrough. It also secures steering shaft 114 to rear frame assembly 84. Left and right braces 122, 124 include left and right brackets 130, 132 at their lower portions. Left and right brackets 130, 132 secure left and right braces 122, 124 to tunnel 86 of snowmobile 22.

It should be noted that, while the construction of frame assembly 84 is illustrated involves the use of tubular members, frame assembly 84 may also be constructed according to a monocoque or pseudo-monocoque technique. A monocoque construction is one where a single sheet of material is attached to an underlying frame (such as with the construction of an aircraft). The skin applied to the frame adds rigidity to the underlying frame structure. In a similar manner, a pseudo-monocoque technique provides a rigid structure by providing a frame constructed from a single sheet of material.

Instead of constructing frame assembly 84 from a number of tubular members, frame assembly 84 may be constructed from a single sheet of material (such as aluminum) that has been pressed or molded into the appropriate shape using a pseudo-monocoque manufacturing technique. As would be understood by those skilled in the art, this would result in a construction that has a high strength with a low weight.

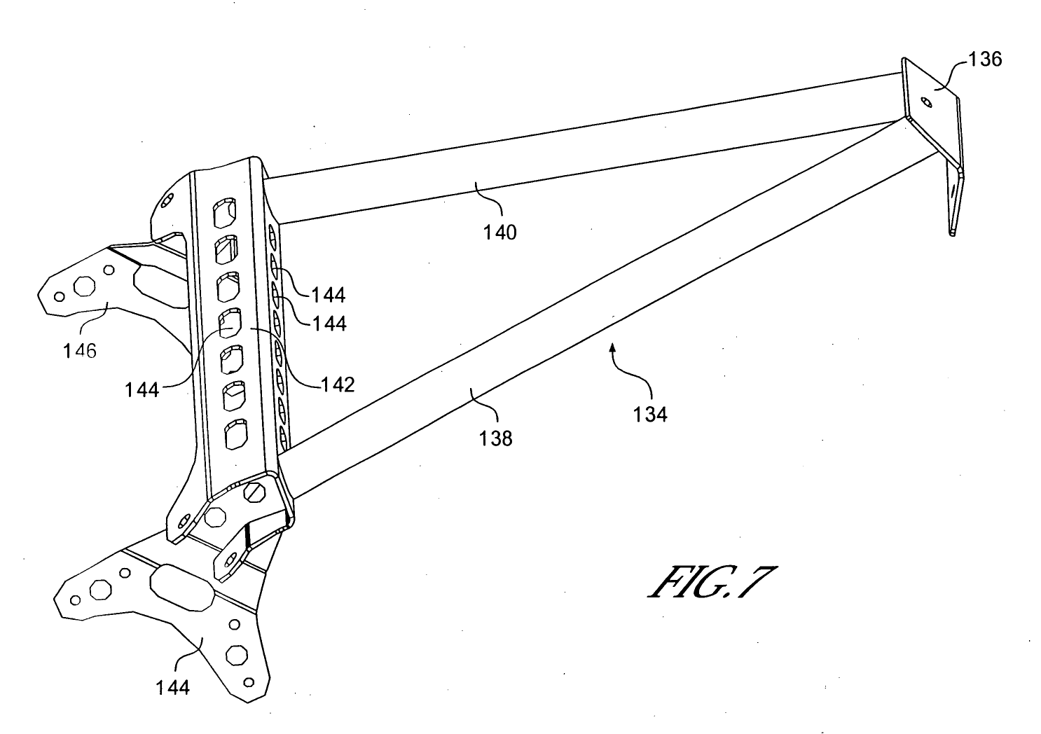

FIG. 7 illustrates a forward support assembly 134 (also called front triangle 134), which connects to bracket 126 and extends forwardly of bracket 126. Forward support assembly 134 includes a bracket 136 at its rear end that connects to bracket 126 of frame assembly 84 (preferably bolted). Forward support assembly 134 also has left and right braces 138, 140 that extend forwardly and downwardly from bracket 136 and are connected thereto preferably by welding. Left and right braces 138, 140 are connected at their forward ends by a cross-member 142, which includes a plurality of holes 144 therein to lighten the weight thereof. Left and right connecting brackets 145, 146 are connected to cross-member 142. The left and right connecting brackets 145, 146 connect, in turn, to front suspension 110.

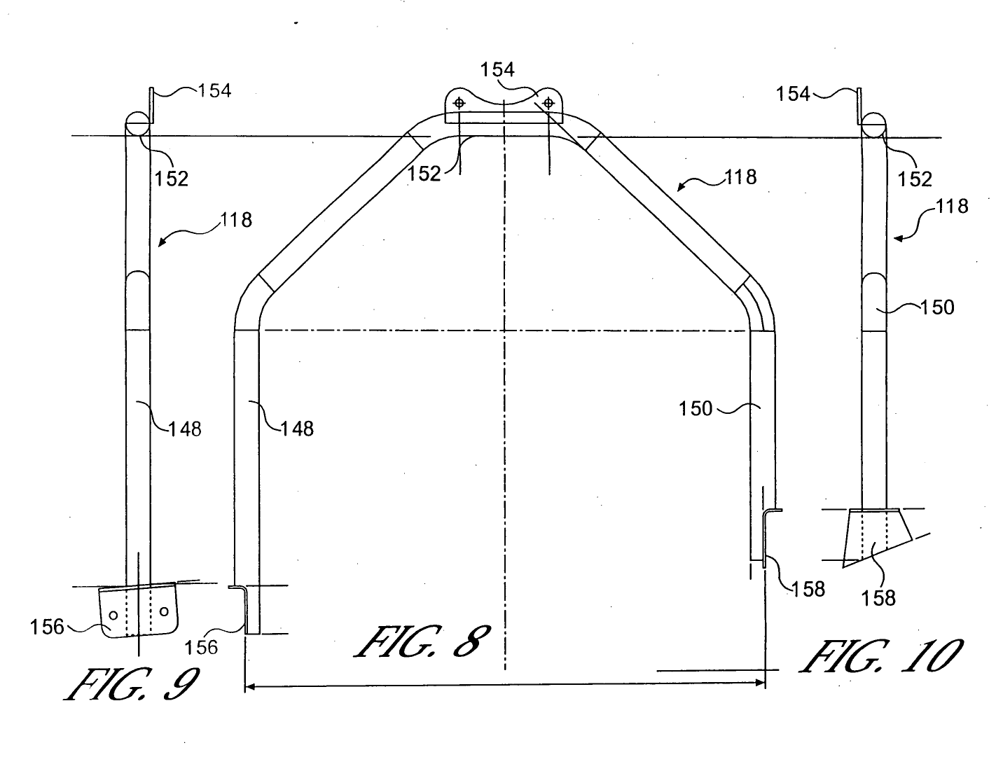

FIG. 8, 9, and 10 illustrate upper column 118 in greater detail. As described above, upper column 118 is essentially an inverted U-shaped member that is preferably tubular in shape to facilitate its construction. Upper column 118 preferably is bent into the appropriate shape from a straight tube with the dimensions shown. As would be understood by those skilled in the art, however, upper column 118 need not be made as a tubular member.

Upper column 118 has left and right legs 148, 150 that extend downwardly from an apex 152. A bracket 154 is disposed at apex 152 for connection to bracket 126 of frame assembly 84. Preferably, bracket 154 is welded at the apex of upper column 118 (however any other suitable attachment means is possible). Left leg 148 includes a bracket 156 at its lower-most portion that connects left leg 148 to engine cradle 88. Similarly, right leg 150 includes a bracket 158 at its lower-most portion to connect right leg 150 to engine cradle 88. Preferably, brackets 156, 158 are welded to upper column 118. Left and right legs 148, 150 preferably attach to engine cradle 88 via bolts or other suitable fasteners.

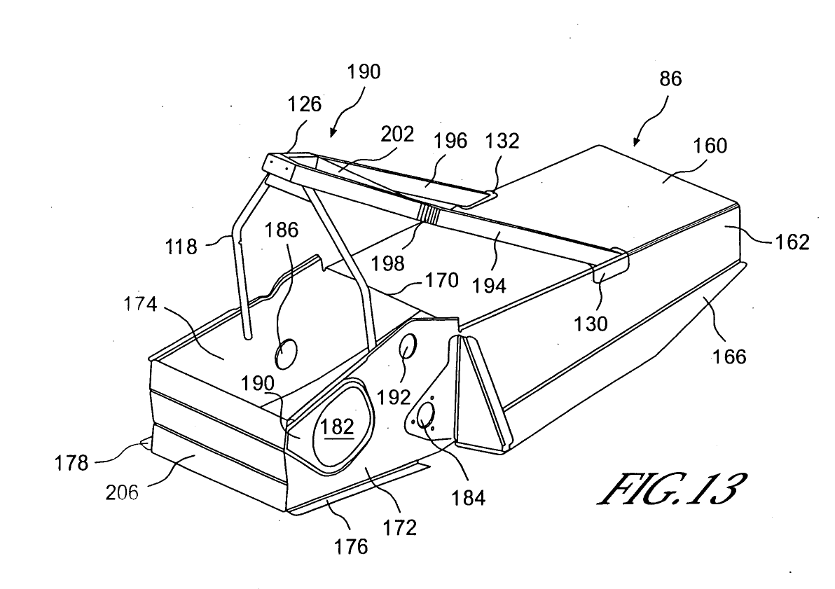

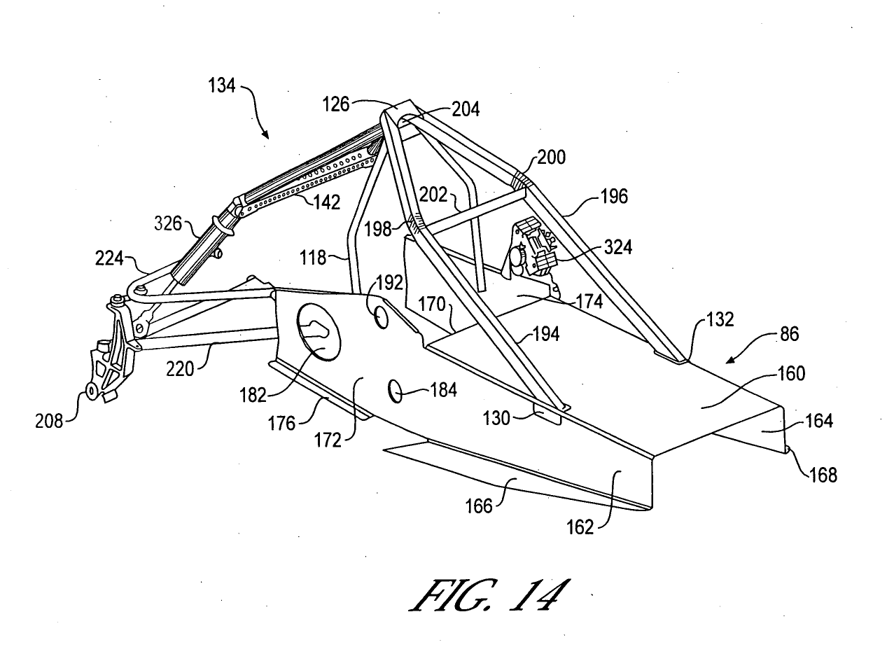

FIGS. 11 and 12 illustrate tunnel 86 in greater detail. Tunnel 86 includes a top plate 160 with left and right downwardly extending side plates 162, 164. A left foot rest 166 extends outwardly from the bottom of left side plate 162. Similarly, a right foot rest 168 extends outwardly from the bottom portion of right side plate 164. Left and right foot rests 166, 168 provide a location along tunnel 86 onto which rider 24 may place his or her feet while operating snowmobile 22.

Left side plate 162 extends forwardly beyond the front portion 170 of tunnel 86 to form a left engine cradle wall 172. Similarly, right side plate 164 extends forwardly of front end 170 of tunnel 86 to form right engine cradle wall 174. At the lower edge of left and right engine cradle walls 172, 174, there are laterally extending portions 176, 178, which serve to strengthen left and right engine cradle walls 172, 174. Removable elements 180 extend between left foot rest 166 and left laterally extending portion 176. Removable portions 180 may or may not be removed between left foot rest 166 and left laterally extending portion 176. FIG. 11 shows removable portions 180 removed, while FIG. 12 shows removable portions 180 not removed. It should be noted that the same removable portions 180 may or may not extend between right foot rest 168 and right laterally extending portion 178.

Left engine cradle wall 172 preferably includes an opening 182 therethrough. Opening 182 permits the shafts from transmission 106 to pass therethrough. Unlike left engine cradle wall 172, right engine cradle wall 174 does not include such an opening. Instead, right engine cradle wall 174 is essentially solid. Due to its construction, right engine cradle wall 174 reflects radiant heat from engine 104 back to engine 104 to assist in minimizing heat dissipation from engine 104. Left and right openings 184, 186 are provided through left and right engine cradle walls 172, 174 so that a drive shaft 188 may pass therethrough. Drive shaft 186 connects to endless track 102 for propulsion of snowmobile 22. Opening 182 may include a member 189 about its periphery, also as illustrated in FIGS. 11 and 12, that provides clearance for the engine. Left engine cradle wall 172 also includes an opening 192 above opening 184 through which a shaft passes for part of transmission 106.

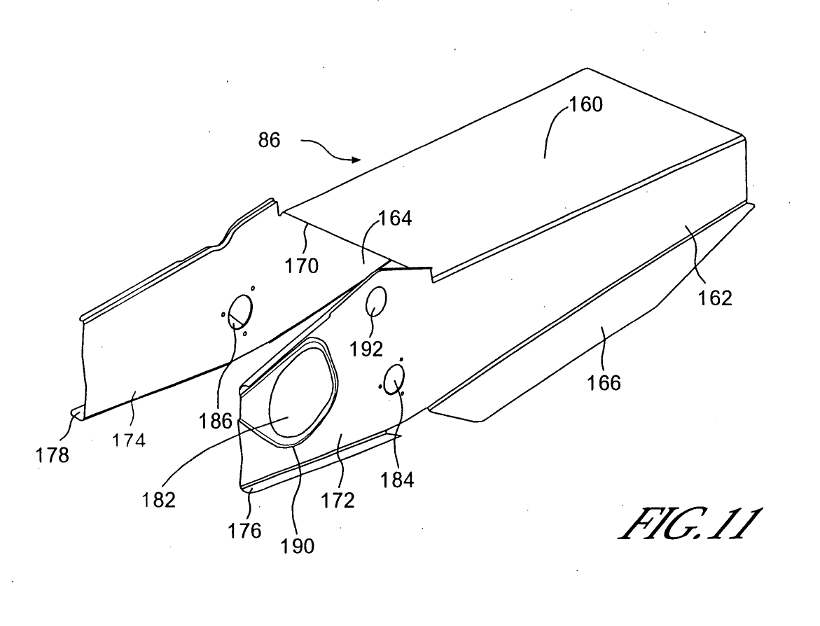

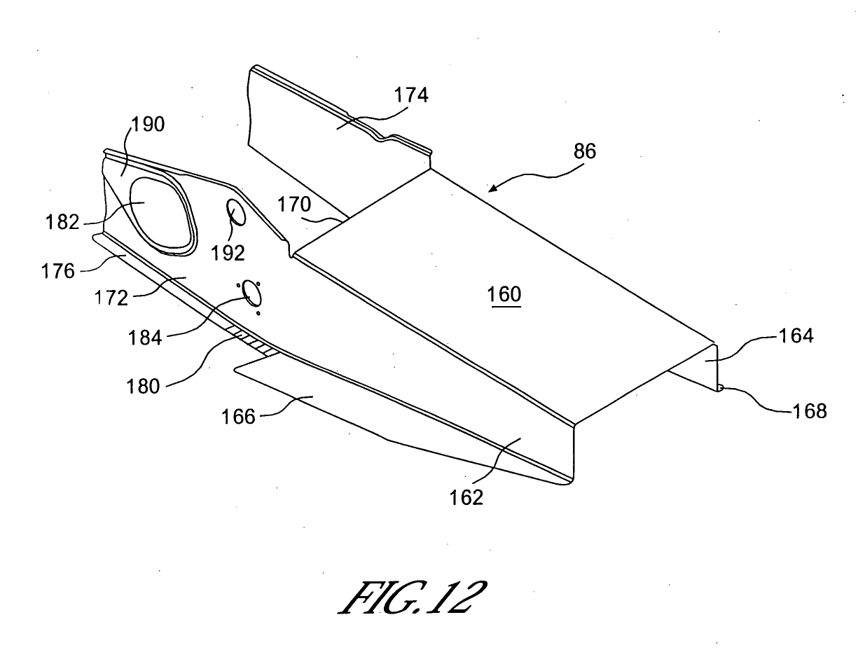

FIGS. 13 and 14 illustrate a combination of a variation of frame assembly 190 connected to tunnel 86. Frame assembly 190 includes upper column 118 as illustrated in FIGS. 8-10. However, frame assembly 190 differs somewhat from frame assembly 84. For example, left and right braces 194, 196 are shaped so that they extend outwardly from the positions defined by left and right braces 122, 124. As illustrated, left and right braces 194, 196 include elbows 198, 200. A cross-brace 202 optionally may be placed between left and right braces 194, 196 to add structural rigidity to frame assembly 190. As with frame assembly 84, a bracket 126 is provided at apex 204 where left and right braces 194, 196 meet one another. Forward support assembly 134 is the same as depicted in FIG. 7. A front engine cradle wall 206 is also shown in FIG. 13.

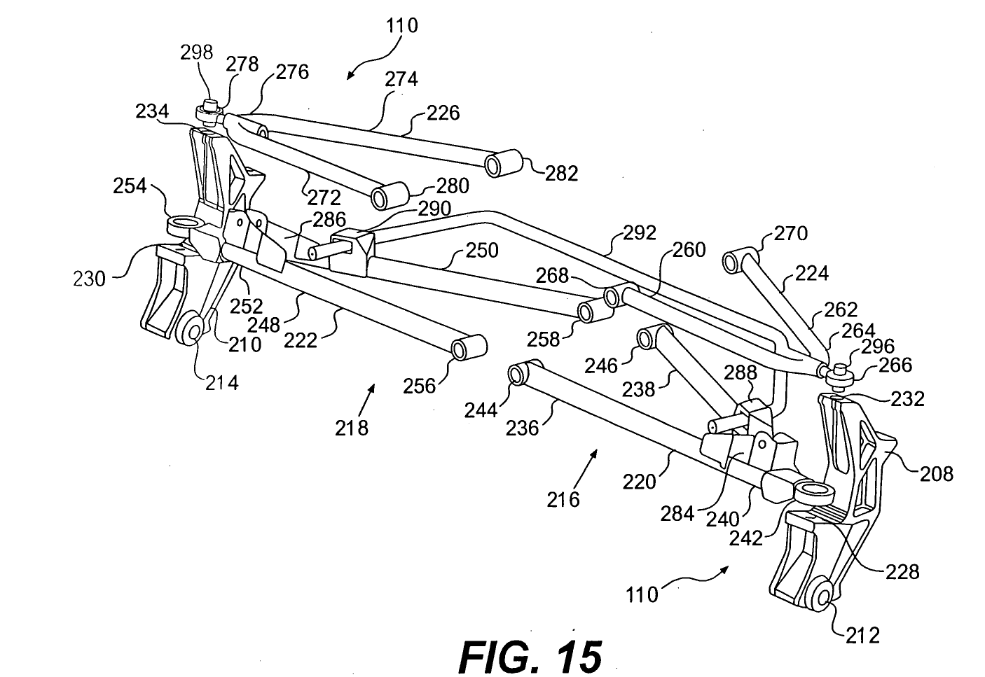

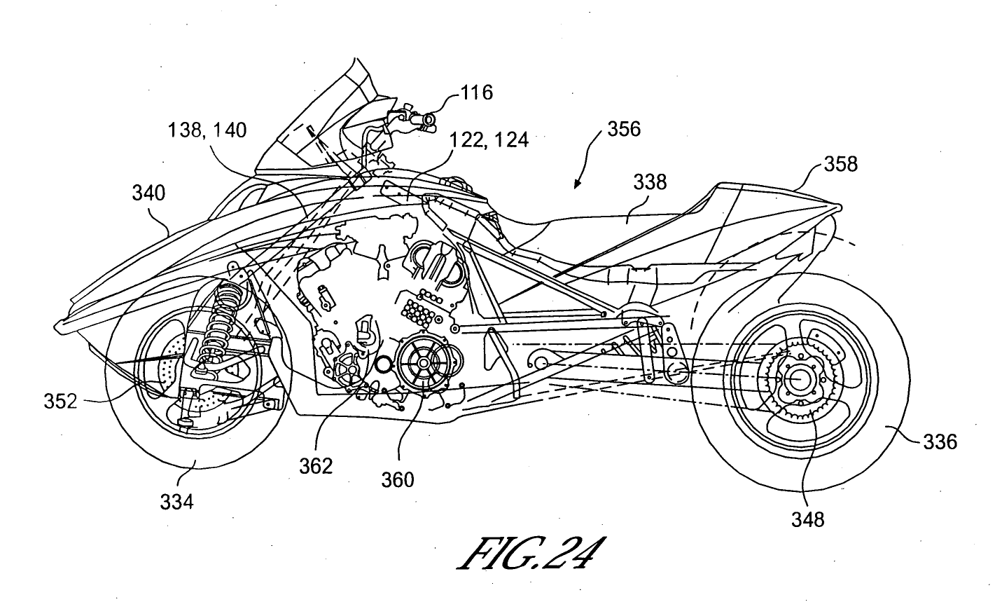

FIGS. 15-17 illustrate various aspects of front suspension 110 and associated structures. While the figures illustrate the embodiment preferably used in combination with snowmobile 22, it should be recognized that front suspension 110 may also be used in combination with a wheeled vehicle, as will be discussed in connection with FIGS. 23-27.

Front suspension 110 includes left and right ski legs 208, 210. Left and right ski legs 208, 210 are preferably made from aluminum and are preferably formed as extrusions. While an aluminum extrusion is preferred for left and right ski legs 208, 210, those skilled in the art would appreciate that ski legs could be made from any suitable material and in any acceptable manner that would provide similar strength and low weight characteristics. Left and right ski legs 208, 210 include holes 212, 214 through which a fastener (not shown) is disposed to pivotally connect skis 32 to snowmobile 22, as shown in FIG. 2.

Left and right ski legs 208, 210 are movably connected to left and right support arms 216, 218. Left and right suspension arms 216, 218 include lower left and right suspension support arms 220, 222 and upper left and right suspension support arms 224, 226.

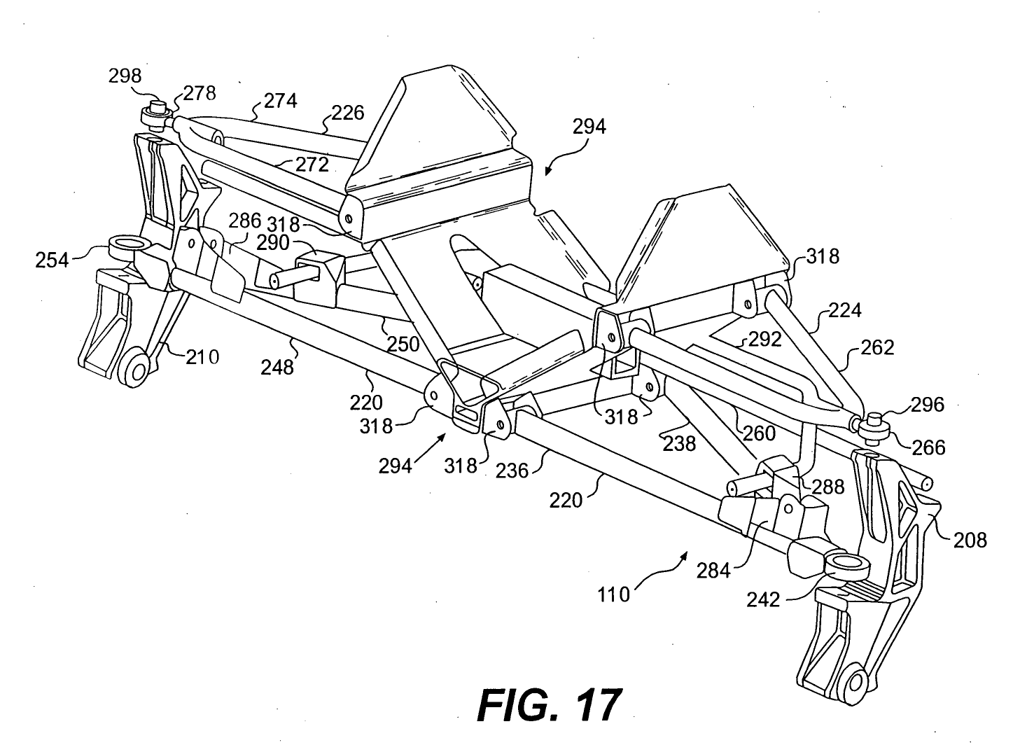

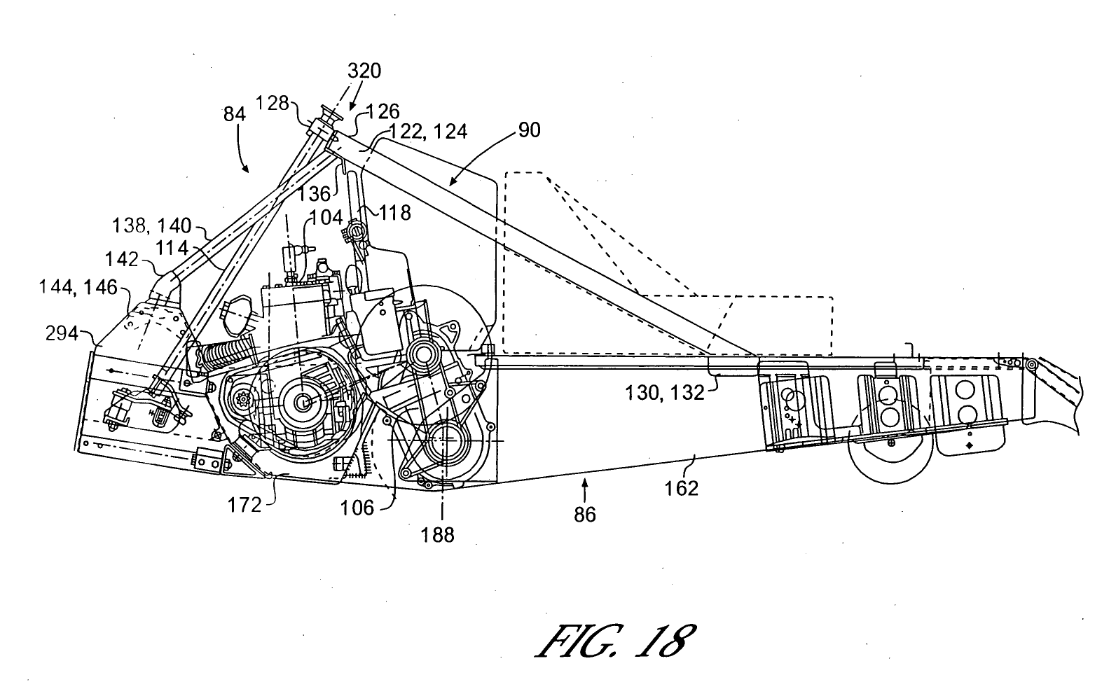

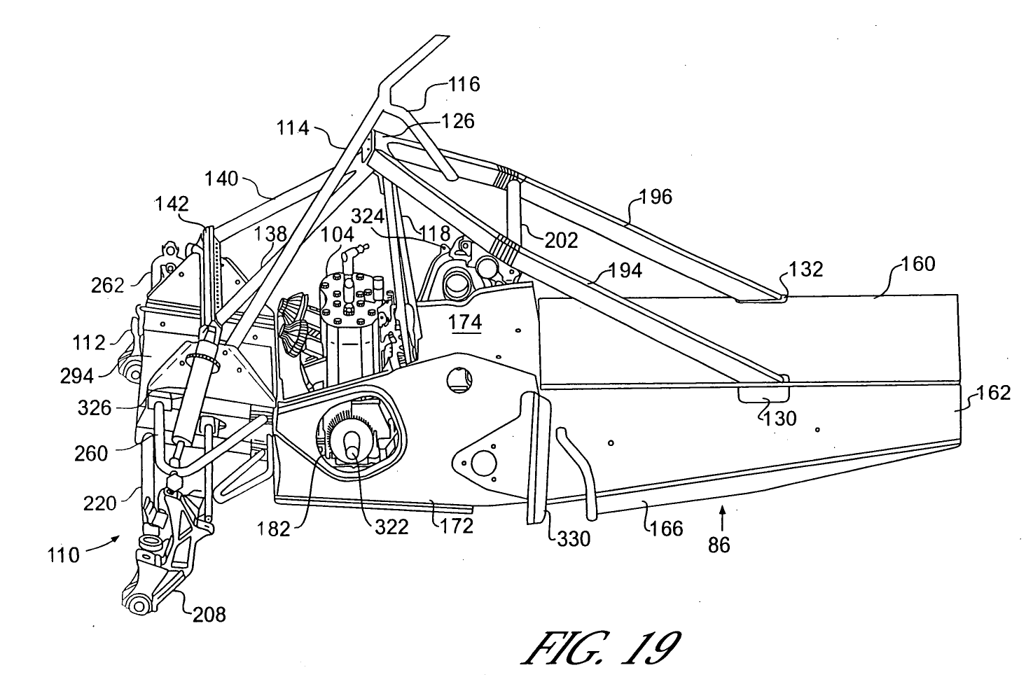

As shown in FIGS. 15 and 17, lower left suspension support arm 220 connects to left ski leg at lower left attachment point 228 preferably through a ball joint (not shown) so that left ski leg 208 may pivot and rotate with respect to lower left suspension support arm 220. Similarly, lower right suspension support arm 222 connects to right ski leg 210 at lower right attachment point 230, preferably through a ball joint. Upper left suspension support arm 224 preferably attaches to left ski leg 208 at upper left attachment point 232, preferably through a ball joint or other suitable means. In addition, upper right suspension support arm 226 connects to right ski leg 210 at upper right attachment point 234 through a ball joint or other suitable means.

Lower left suspension support arm 220 includes front and rear members 236, 238, which meet at apex 240 where they connect with left lower eyelet 242. Front member 236 includes a joint 244 at an inner end, and rear member 238 includes a joint 246 also at an inner end. Similarly, lower right suspension support arm 222 includes front and rear members 248, 250, which meet at apex 252 where they connect with right lower eyelet 254. Front member 248 includes a joint 256 at an inner end and rear member 250 includes a joint 258 also at an inner end.

Upper left suspension support arm 224 includes front and rear members 260, 262, which meet at apex 264 where they connect with upper left eyelet 266. Front member 260 includes a joint 268 at an inner end, and rear member 262 includes a joint 270 also at an inner end. Similarly, upper right suspension support arm 226 includes front and rear members 272, 274, which meet at apex 276 where they connect with upper right eyelet 278. Front member 272 includes a joint 280 at an inner end and rear member 274 includes a joint 282 also at an inner end.

At a point inward from apex 240, lower left suspension support arm 220 includes a left bracket 284 that is connected to and extends partially along front and rear members 236, 238. Similarly, lower right suspension support arm 222 includes a right bracket 286 that is connected to and extends partially along front and rear members 248, 250. Slidably attached to rear member 238 of lower left suspension arm 220 is a left pivot block 288. A right pivot block 290 is slidably attached to rear member 250 of lower right suspension support arm 222. A stabilizer bar 292 is connected between left and right pivot blocks 288, 290. Stabilizer bar 292 is adapted to slide and pivot by way of left and right pivot blocks 288, 290. These blocks 288, 290 slide relative to left and right lower suspension support arms 220, 222. Left and right bushings 296, 298 are provided to allow some rotation of the components of front suspension 110. Left and right ski legs 208, 210 rotatably connect to front suspension 110 for facilitating movement of skis 32.

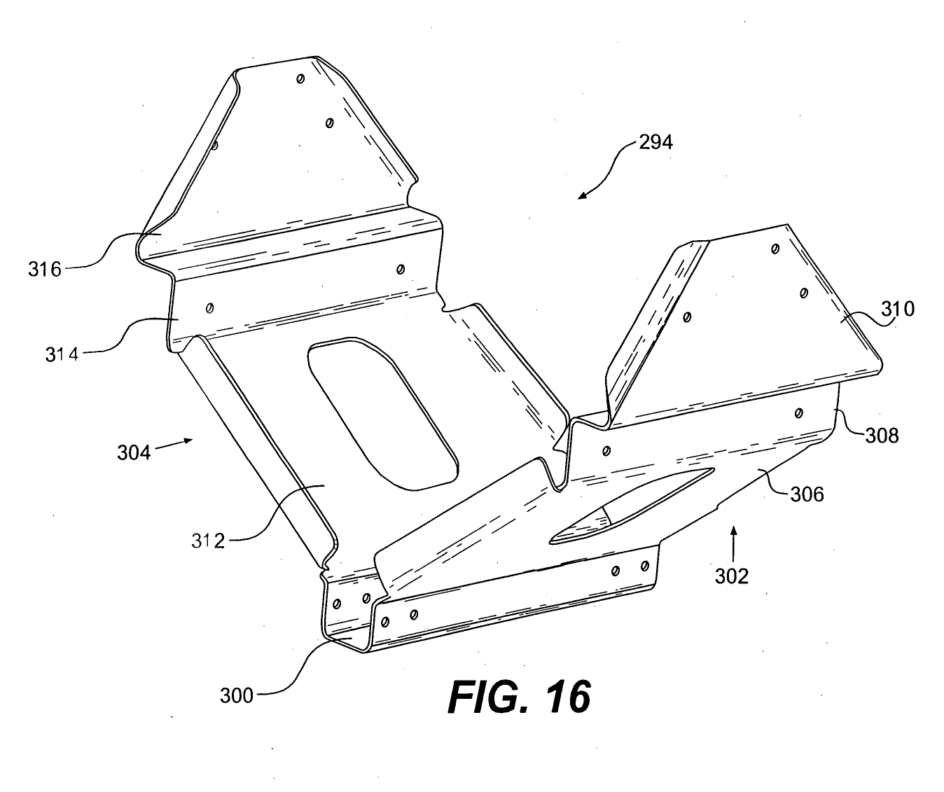

FIG. 16 illustrates sub-frame 294, which is essentially a unitary, V-shaped structure. Sub-frame 294, which forms a part of front suspension 110, includes a central channel 300 flanked on either side by left and right upwardly extending panels 302, 304. Left upwardly extending panel 302 includes a left lower panel 306 connected to left transition structure 308 and left triangular panel 310. Similarly, right upwardly extending panel 304 includes a right lower panel 312 connected to right transition structure 314 and right triangular panel 316. While sub-frame 294 preferably is a unitary structure (an integrally-formed structure), sub-frame 294 need not be constructed in this manner. As would be understood by those skilled in the art, sub-frame 294 may be assembled from a number of separate elements that are connected together by any suitable means such as by welding or by fasteners.

As illustrated in FIG. 17, sub-frame 294 is an integral part of front suspension 110 and connects to left support arm 216 and right support arm 218 through a number of brackets 318 connected at various locations on sub-frame 294.

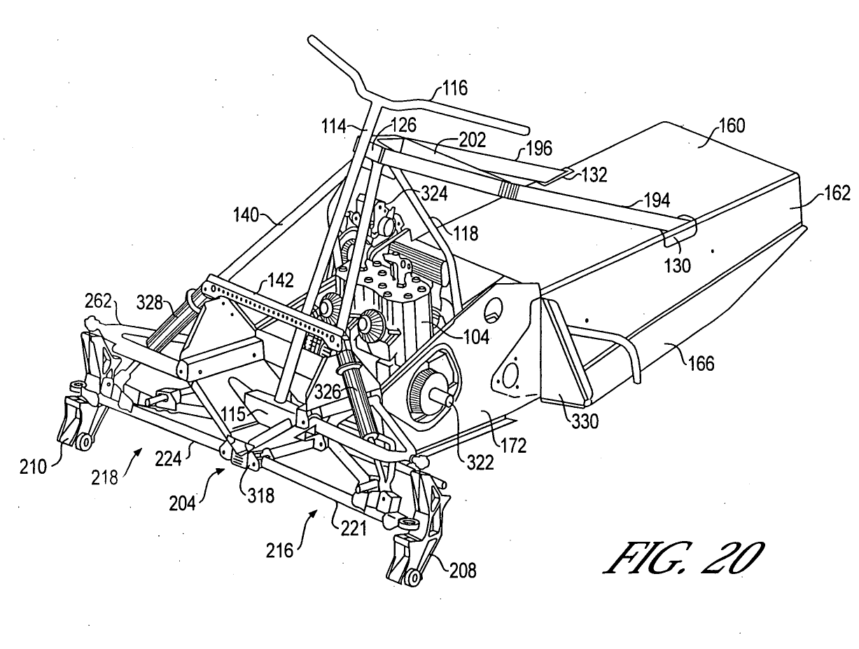

FIG. 18 is a side view of one embodiment of the completed frame assembly 84 of the present invention. As shown, over-arching frame elements 90 are connected between tunnel 86 and sub-frame 294 to establish an apex 320 to which steering shaft 114 is connected.

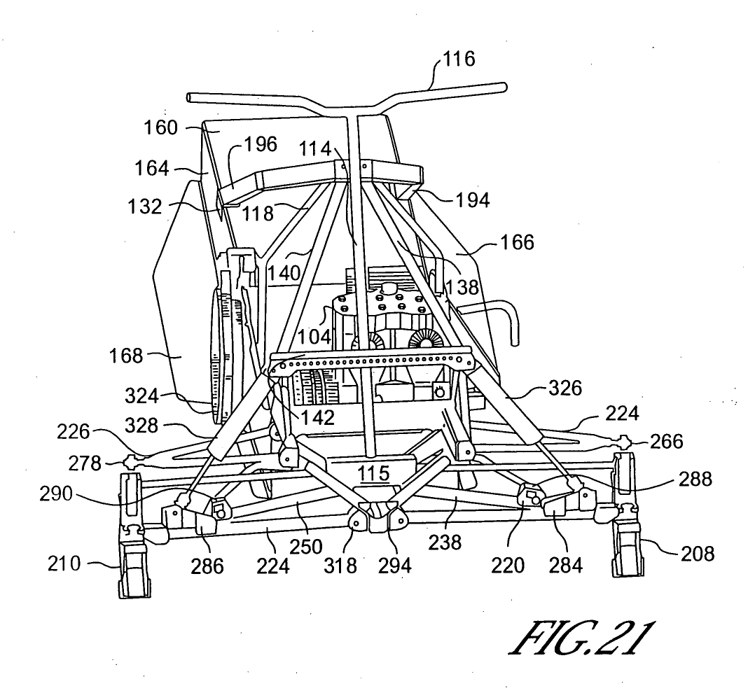

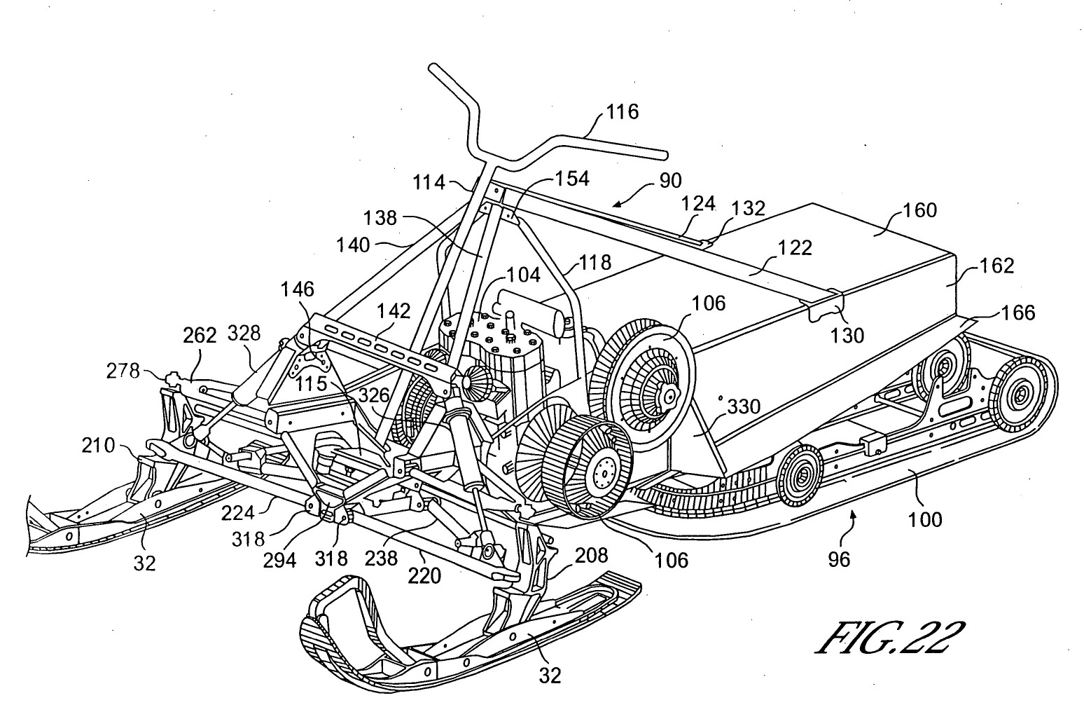

FIG. 19 is a perspective illustration of the embodiment of the present invention shown in FIGS. 13 and 14 to assist in understanding the scope and content of the present invention. As illustrated, drive shaft 322 extends through left opening 182 in left engine cradle wall 172. A portion of gearbox 324 is also visible. In addition, left shock absorber 326, which is connected between cross-member 142 and left support arm 216, is illustrated. Right shock absorber, which extends between cross-member 142 and right support arm 218 is visible in FIG. 20. Furthermore, left forward foot wall 330 is shown at the forward end of left foot rest 166. A similar forward foot wall may be provided on the right side of snowmobile 22 (but is not illustrated herein).

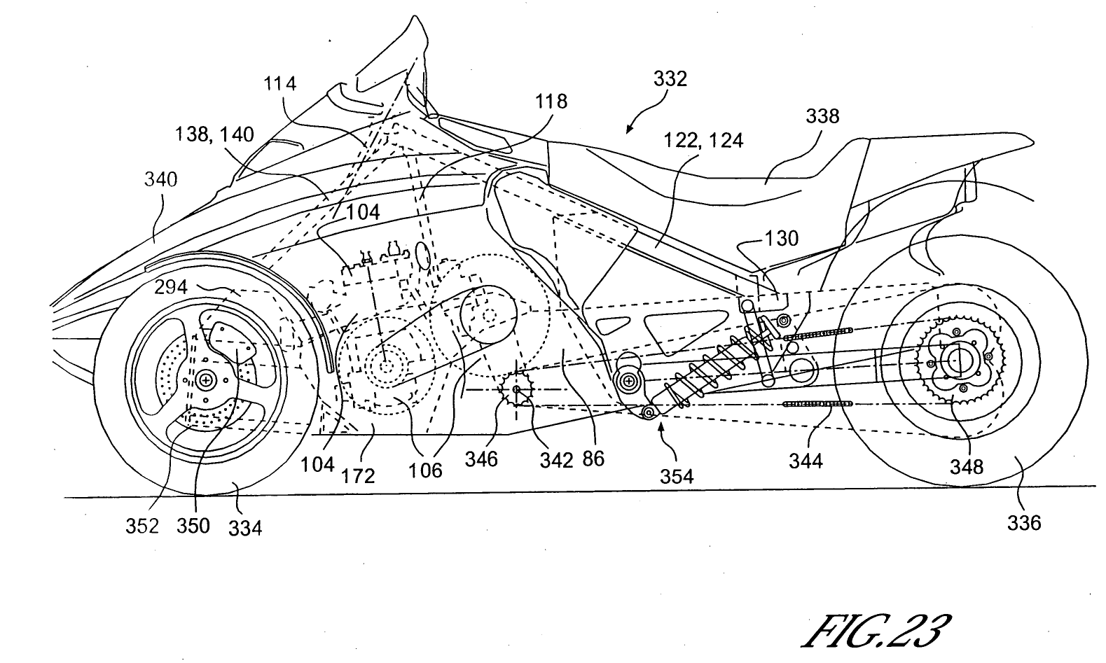

FIGS. 20 and 21 illustrate further details of the present invention by showing the various elements from slightly different perspective views. FIG. 22 illustrates the modified version of the elements of the present invention shown in FIGS. 6 and 7. Here, left and right braces 122, 124 are illustrated instead of left and right braces 194, 196. As discussed previously, left and right braces 122, 124 differ from left and right braces 194, 196 in that they are not bent but, instead, are straight elements of overarching frame 90. The same left and right braces 122, 124 are shown in FIG. 18. As would be understood by those skilled in the art, the two different embodiments of these braces are interchangeable. In addition, their shape may be altered depending on the requirements of the particular vehicle design, as would be understood by those skilled in the art.

Left and right braces 194, 196 are bent to accommodate an airbox (not shown) between them. Left and right braces 122, 124 are not bent because they do not need to accommodate an airbox.

FIG. 20 also illustrates steering gear box 115 at the bottom end of steering shaft 114 that translates the movement of handlebars 116 into a steering motion of skis 32.

FIGS. 23-27 illustrate alternate embodiments of the present invention that are designed for a wheeled vehicle 332, rather than a snowmobile 22. For the most part, the elements designed for wheeled vehicle 332 are the same as those for snowmobile 22, except for those elements required to attach wheels 334 to wheeled vehicle 332.

In the preferred embodiment of wheeled vehicle 332, the vehicle includes two front wheels 334 and a single rear wheel 336. As would be understood by those skilled in the art, however, wheeled vehicle 332 may be constructed with two rear wheels rather than one. If so, wheeled vehicle 332 would be a four-wheeled vehicle rather than the three-wheeled vehicle shown.

Wheeled vehicle 332 includes a seat 338 disposed over tunnel 86 in the same manner as snowmobile 22. The vehicle includes engine 104 at its forward end, encased by fairings 340. Fairings 340 protect engine 104 and provide wheeled vehicle 332 with an aesthetically pleasing appearance. Engine 104 is connected to CVT 106, which translates the power from engine 104 into motive power for wheeled vehicle 332.

As shown in FIG. 23, CVT 106 is connected by suitable means to drive shaft 342, which is connected to rear wheel 336 by a drive chain 344. A sprocket 346 is connected to drive shaft 342. A similar sprocket 348 is provided on the shaft connected to rear wheel 336. Drive chain 344 is an endless chain that connects sprockets 346, 348 to one another. To stop wheeled vehicle 332 during operation, disc brakes 350 are connected to front wheels 334. Disc brakes 350 clamp onto discs 352 to slow or stop wheeled vehicle 332 in a manner known to those skilled in the art.

A rear suspension 354 is provided under tunnel 86. Rear suspension 354 absorbs shocks associated with the terrain over which wheeled vehicle 332 travels. Rear suspension 354 replaces rear suspension 28 on snowmobile 22.

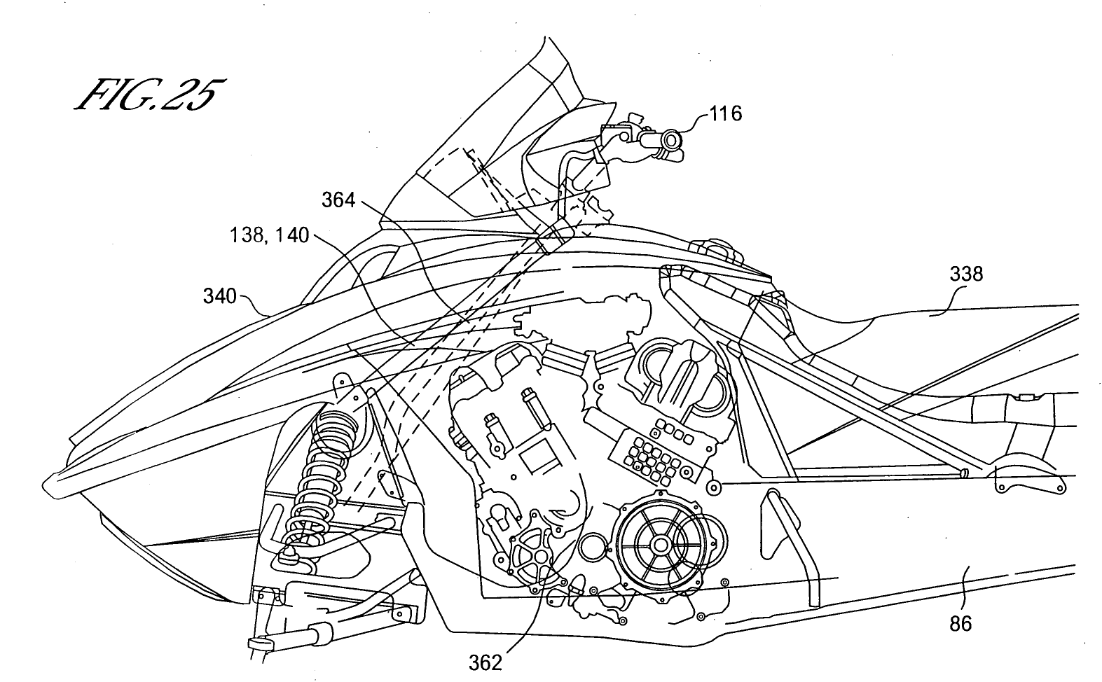

FIG. 24 illustrates an alternate embodiment of wheeled vehicle 356. Wheeled vehicle 356 differs in its construction at the rear. Specifically, rear end 358 is shorter than that shown for wheeled vehicle 332. In addition, wheeled vehicle 356 includes a four stroke engine, rather than the two stroke engine 104 illustrated for wheeled vehicle 332. Also, wheeled vehicle 356 includes a manual speed transmission 360 (with a clutch) rather than continuously variable transmission 106, as illustrated with other embodiments of the present invention. Both constructions of the wheeled vehicle, as well as many other variations, are contemplated within the scope of the present invention. In addition, as discussed above, the present invention may be used with a two or four stroke engine (or any other type of engine that provides the motive power for the vehicle).

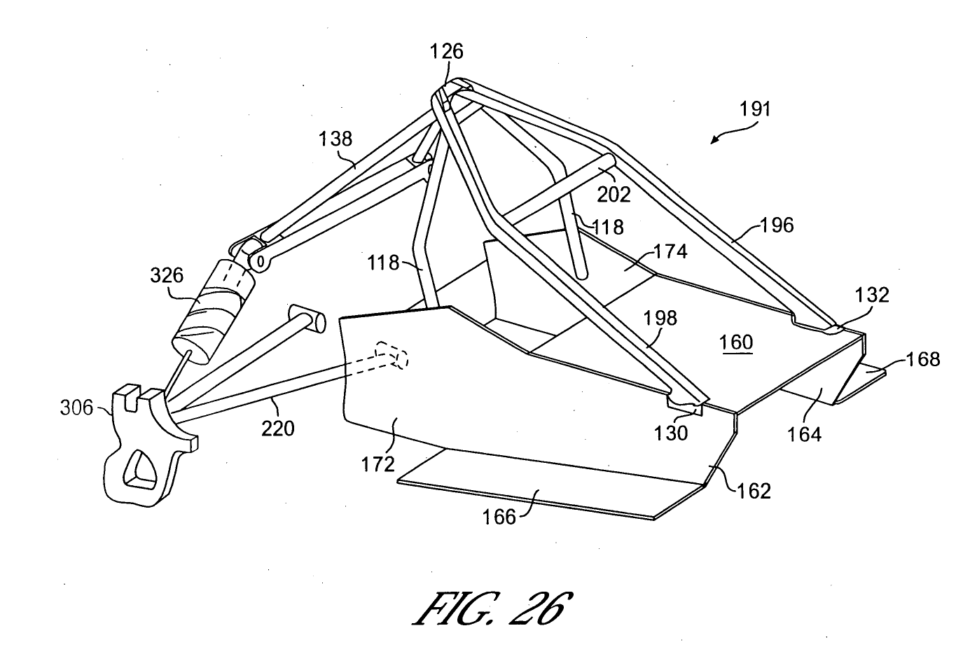

FIG. 25 illustrates in greater detail the embodiment of the present invention shown in FIG. 24.

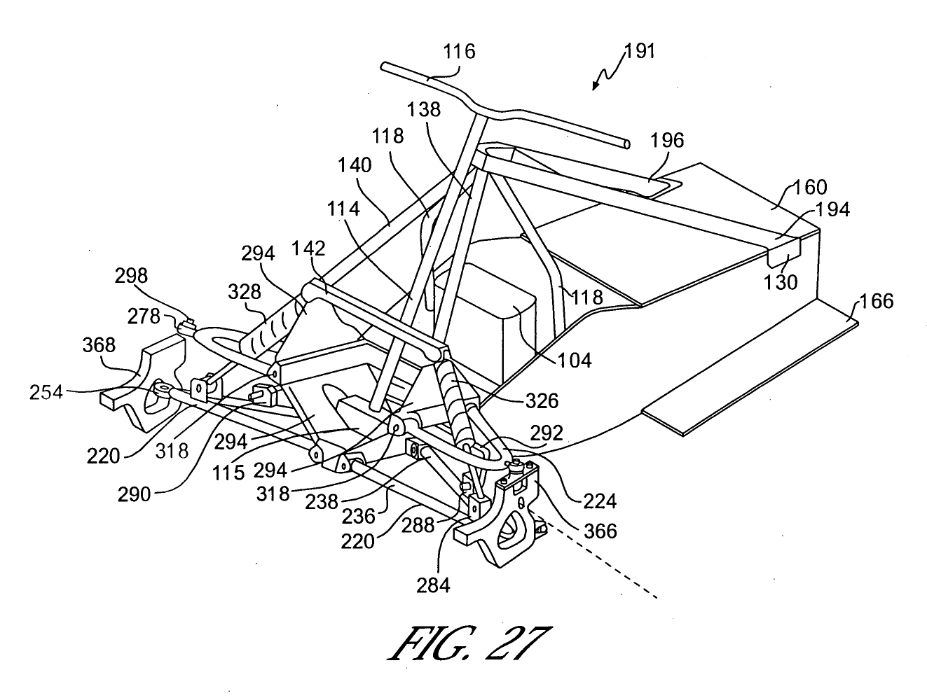

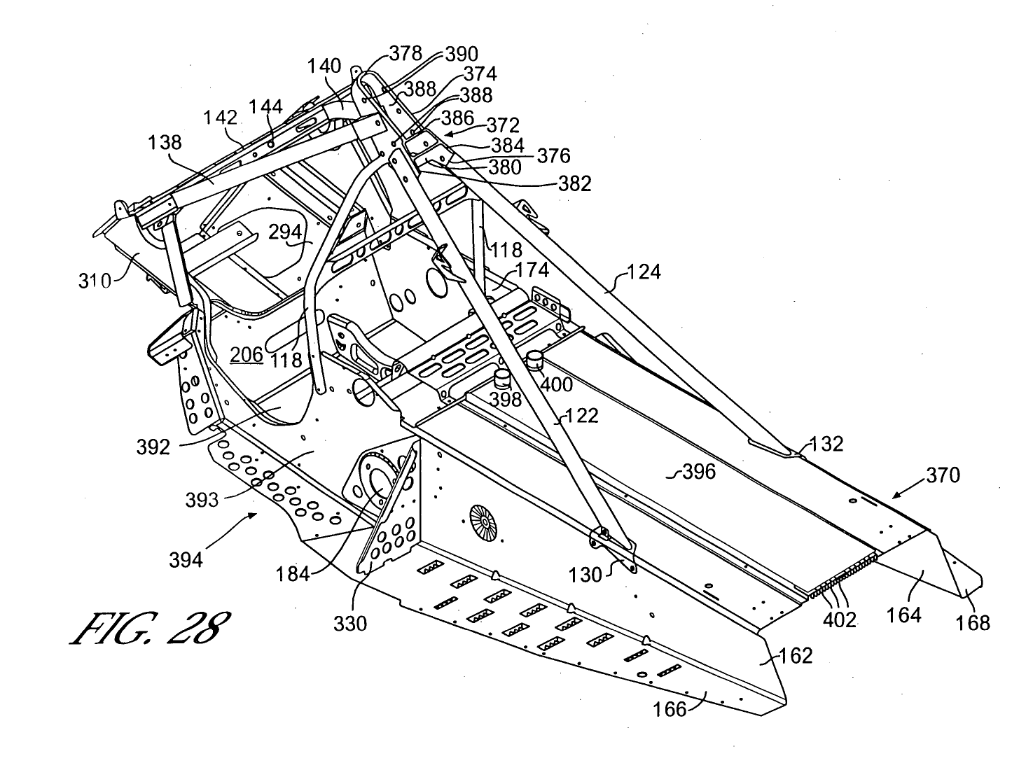

FIGS. 26-27 illustrate the basic frame assembly contemplated for wheeled vehicles 332, 356. For either vehicle, the construction of frame assembly 191 is similar to that previously described. This embodiment differs in that left and right wheel knuckles 366, 368 are provided so that wheels 334 may be attached thereto. In most other respects, the construction of frame assembly 191 is the same as that previously described.

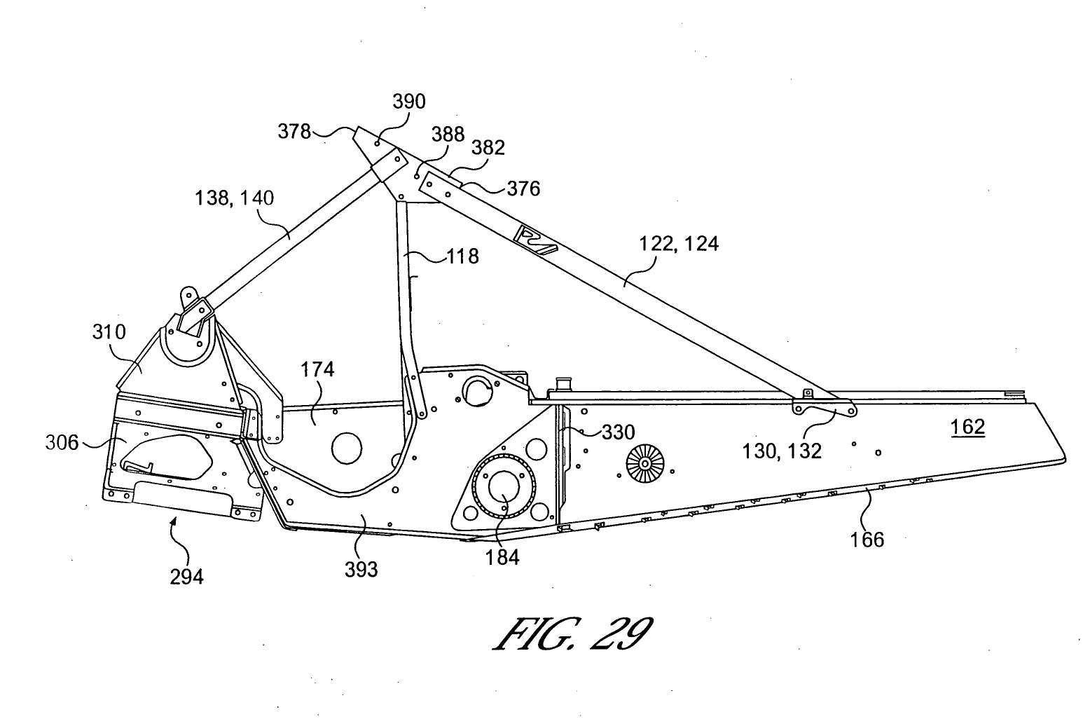

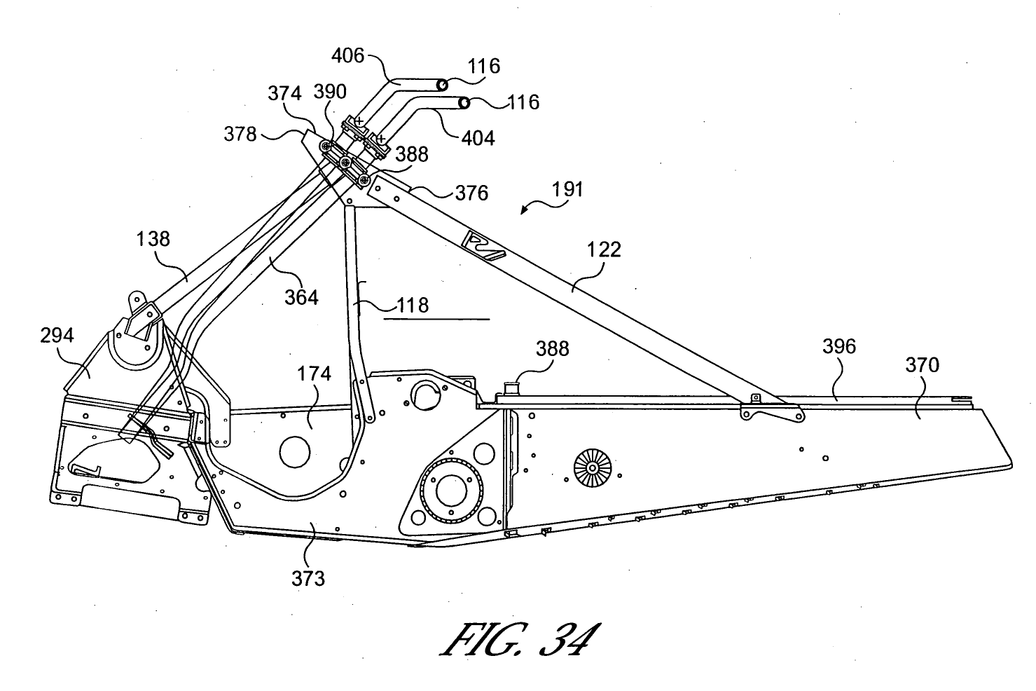

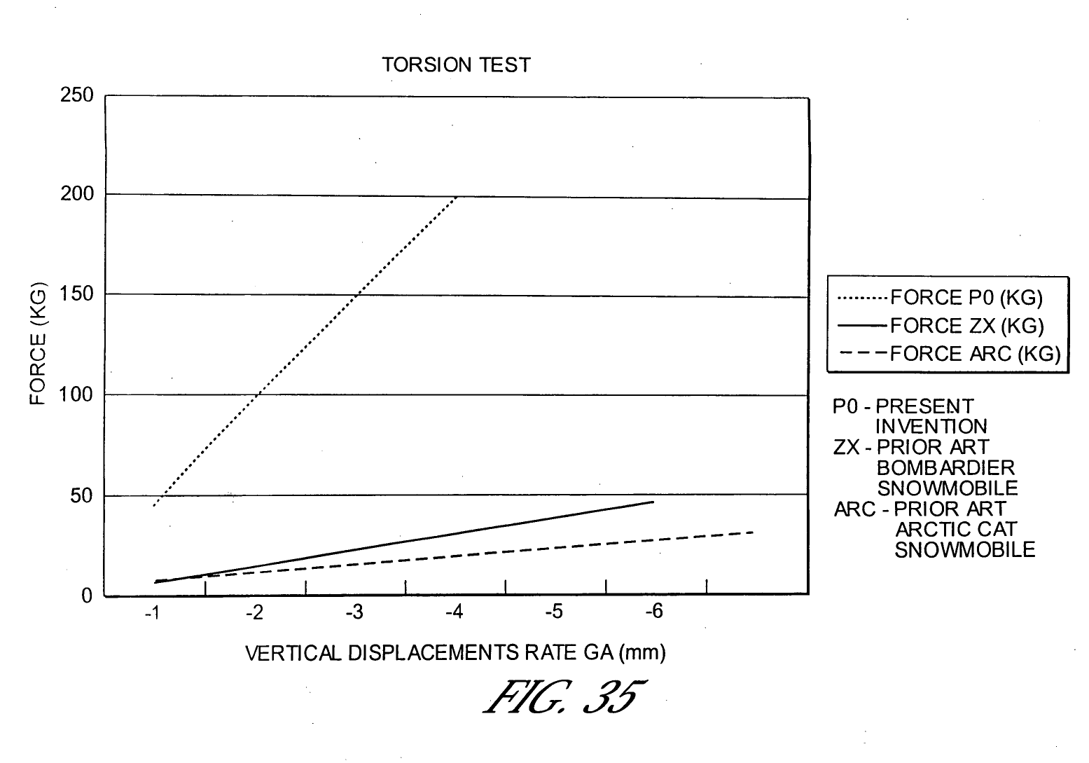

The variable geometry of steering shaft 364 will now be described in connection with FIGS. 28-34.

As illustrated in FIG. 28, left brace 122 and right brace 124 extend upwardly from tunnel 370 to apex 372 where they connect to variable geometry steering bracket 374. Upper column 118 extends from left engine cradle wall 376 and right engine cradle wall 174 and also connects to variable geometry steering bracket 374. Forward support assembly 134 extends from sub-frame 294 to variable geometry steering bracket 374.

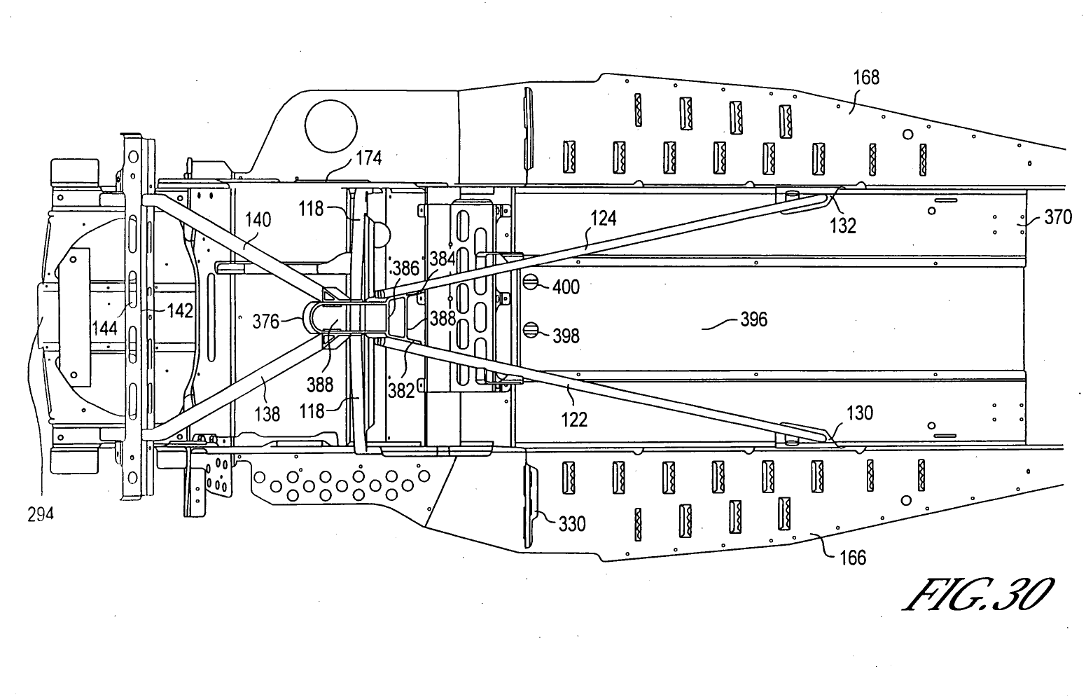

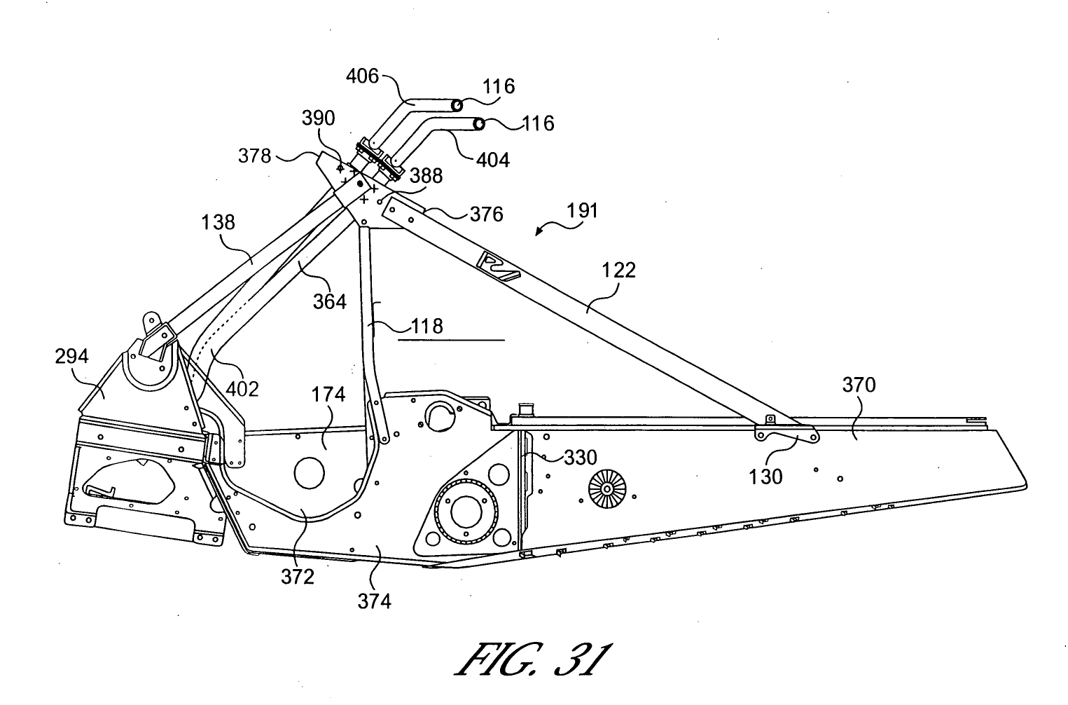

Variable geometry steering bracket 374 is essentially a U-shaped element with a rear end 376 and a forward end 378. At rear end 376, a first cross-member 380 extends between left and right legs 382, 384 of variable geometry steering bracket 374 to define a closed structure. A second cross member 386 extends between left and right legs 382, 384 forward of first cross member 380 and defines a U-shaped opening 387 toward forward end 378 of variable geometry steering bracket 374. A first pair of holes 388 and a second pair of holes 390 are disposed through left and right legs 382, 382 of variable geometry steering bracket 374 and provide separate attachment points for steering shaft 364. FIG. 29 illustrates the same structures in side view and FIG. 30 illustrates the same structures in top view.

This embodiment of the frame assembly of the present invention differs from the previous embodiments in a few respects. First, left engine cradle wall 393 includes a C-shaped opening 392 instead of opening 182. C-shaped opening 392 facilitates maintenance of an engine (not shown) in engine cradle 394. Second, an elongated radiator 396 is integrated into tunnel 370. Radiator 396 includes an inlet 398 and an outlet 400 that are connected to the cooling system of the engine to assist in reducing the temperature of the coolant therein. To facilitate dissipation of heat, radiator 396 includes fins 402 on its underside.

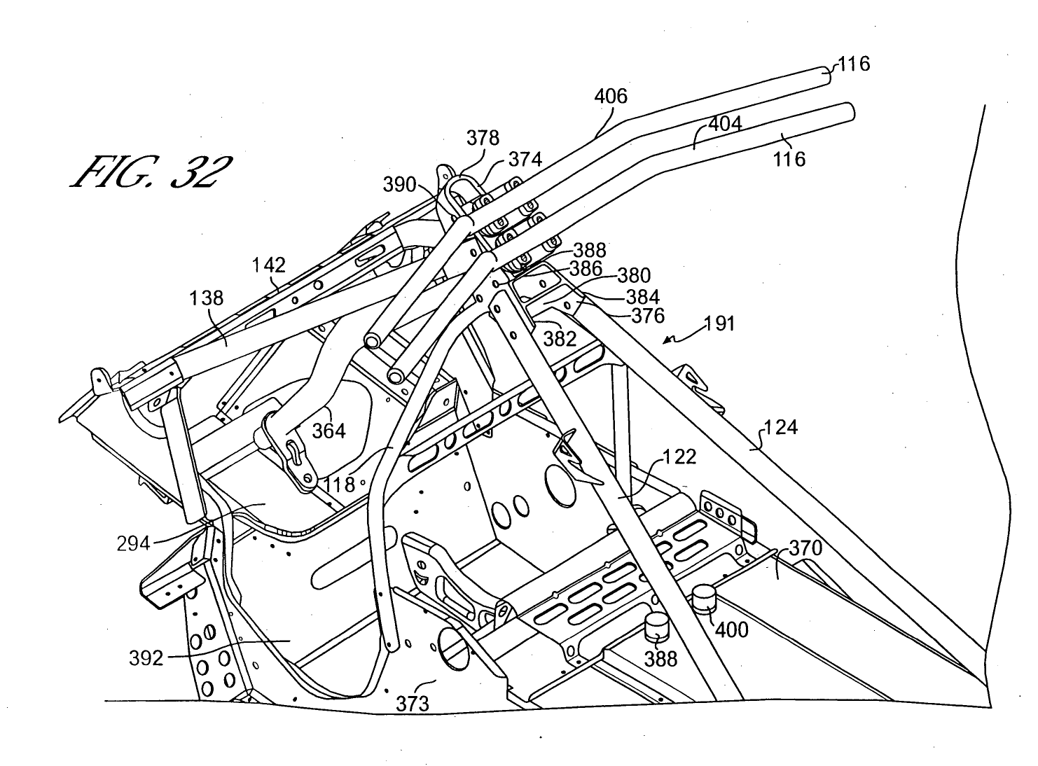

FIG. 31 provides another side view of the frame assembly of the present invention and illustrates the two positions of steering shaft 364 made possible by the construction of variable geometry steering bracket 374. To accommodate the variable geometry of steering shaft 362 and handlebars 116, steering shaft 364 includes a bend 402 at its lower end. Steering shaft 364 passes through a bearing or bushing (not shown) at its upper end that is connected to variable geometry steering bracket 374 at either of first or second pairs of holes 388, 390. By selecting either first or second pairs of holes 388, 390, first and second handlebar positions 404, 406 are selectable. As would be recognized by those skilled in the art, however, variable geometry steering bracket 374 may be provided with greater that two pairs of holes 388, 390 to further increase the variability handlebars 116. Also, variable geometry steering bracket 374 may be provided with a construction that permits infinite variation of the position of handlebars, as would be understood by those skilled in the art, should such a construction be desired.

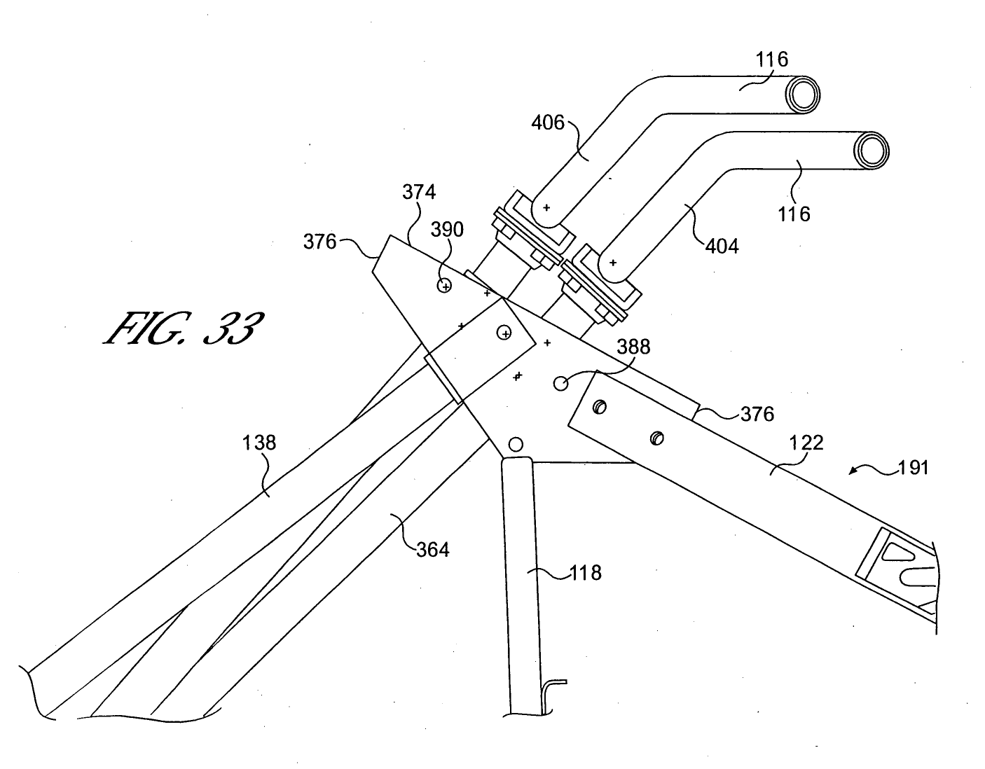

FIGS. 32-34 provide additional views of the variable positioning of the handlebars 116 to facilitate an understanding of the scope of the present invention.

Frame assembly 84, 190, 191 of the present invention uniquely distributes the weight loaded onto the vehicle, whether it is snowmobile 22 or one of wheeled vehicles 332, 356. Each of the main components of the frame assembly 84, 190, 191 forms a triangular or pyramidal configuration. All of the bars of the frame assembly 84, 190, 191 work only in tension and compression, without bending. Therefore, each bar of frame assembly 84, 190, 191 intersects at a common point, the bracket 126 (in the non-variable steering geometry) or variable geometry steering bracket 374. With this pyramidal shape, the present invention creates a very stable geometry.

Specifically, the structure of frame assembly 84, 190, 191 enhances the torsional and structural rigidity of the frame of the vehicle. This improves handling. Usually, with a snowmobile, there is only a small torsional moment because the width of the snowmobile is only about 15 inches. An ATV, on the other hand, has a width of about 50 inches and, as a result, experiences a significant torsional moment. Therefore, to construct a frame assembly that is useable in either a snowmobile or an ATV, the frame must be able to withstand the torsional forces associated with an ATV.

Not only does frame assembly 84, 190, 191 reduce torsional bending, it also reduces the bending moment from front to rear. The increased rigidity in both directions further improves handling.

In addition, the creation of frame assembly 84, 190, 191 has at least one further advantage in that the frame can be made lighter and stronger than prior art frame assemblies (such as frame assembly 52, which is illustrated in FIG. 4). In the conventional snowmobile, frame assembly 52 included a tunnel 54 and an engine cradle 56 that were riveted together. Because frame assembly 84, 190, 191 adds strength and rigidity to the overall construction and absorbs and redistributes many of the forces encountered by the frame of the vehicle, the panels that make up the tunnel 86 and the engine cradle 88 need not be as strong or as thick as was required for the construction of frame assembly 52.

In the front of the vehicle, left and right shock absorbers 326, 328 are connected to forward support assembly 134 so that the forces experienced by left and right shock absorbers 326, 328 are transmitted to frame assembly 84, 190, 191. In the rear of the vehicle, the left and right braces 122, 124 are orientated with respect to the rear suspension. Upper column 118 is positioned close to the center of gravity of the vehicle's sprung weight. The sprung weight equals all of the weight loaded onto the vehicle's entire suspension. The positioning of these elements such that they transmit forces encountered at the front, middle and rear of the vehicle to an apex creates a very stable vehicle that is capable of withstanding virtually any forces that the vehicle may encounter during operation without sacrificing vehicle performance.

FIG. 35 illustrates the degree to which the rigidity of a frame constructed according to the teachings of the present invention is improved. The highest line on the graph shows that for a 100 kg load, the vertical displacement of the frame of the present invention is only −2 mm. However, in the prior art Bombardier ZX™ model snowmobile, a load of only 50 kg produced a vertical displacement of −6 mm. In addition, a load of about 30 kg on the frame for the prior art Arctic Cat® snowmobile produced a vertical displacement of −6 mm. In other words, the structural rigidity of the frame assembly of the present invention is greatly improved.

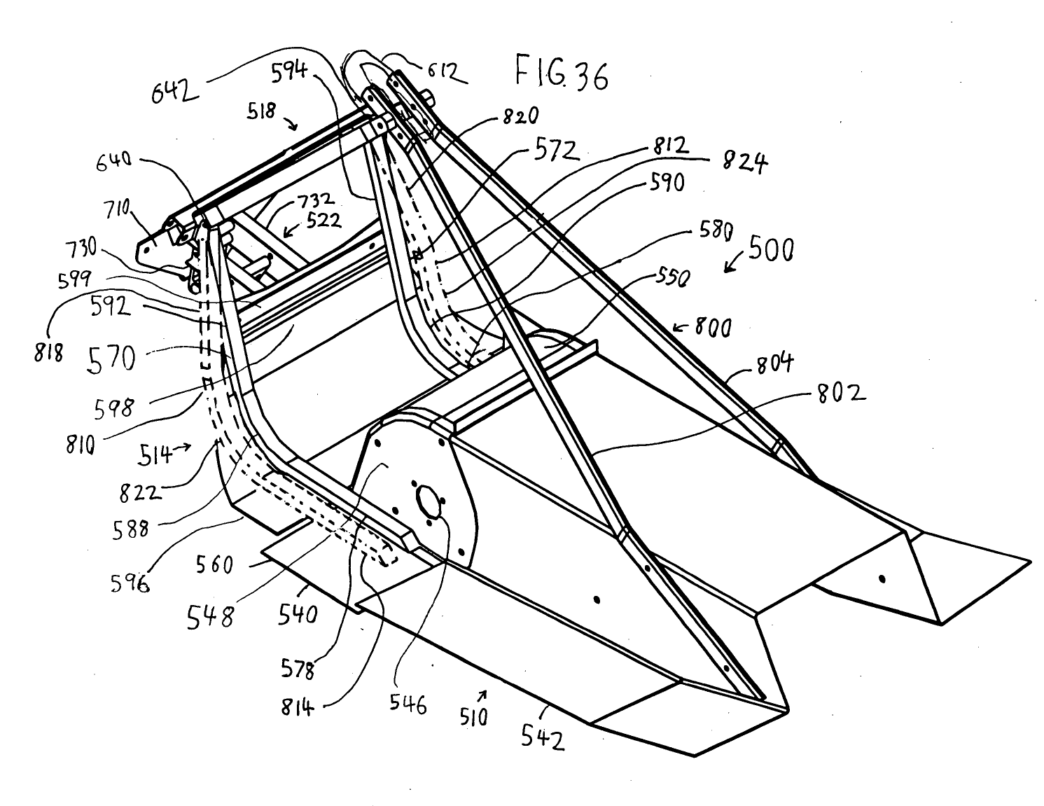

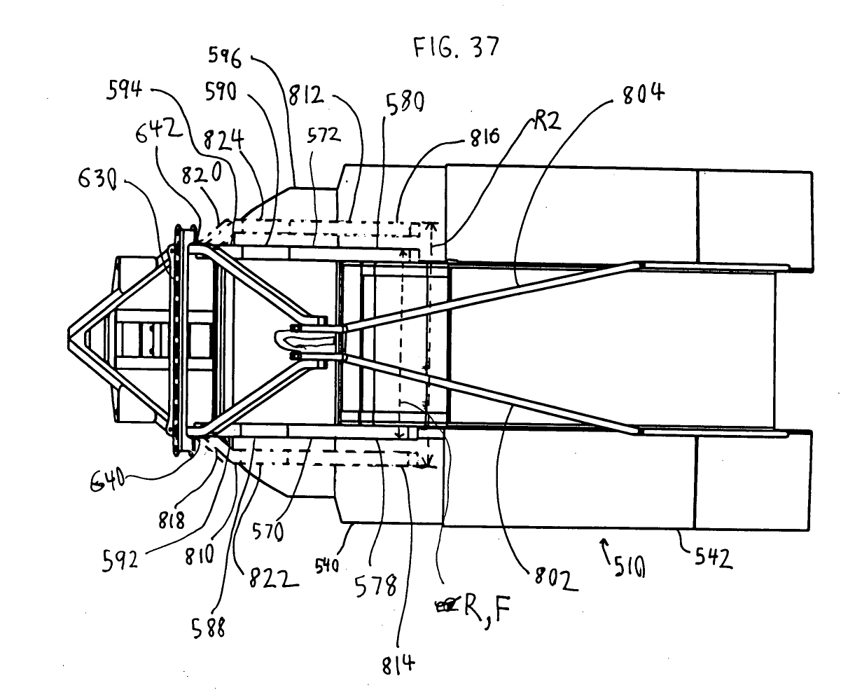

FIGS. 36-40 illustrate an additional alternate embodiment of the present invention. A vehicle frame assembly 500 includes, among other elements, a tunnel 510, an engine support 514, a forward support assembly 518, a suspension arm pivot base assembly 522, and a rear brace assembly 800. An engine is supported by the engine support 514 and operatively connected to a wheel or endless drive track that is supported by the tunnel 510 in a similar manner as in the above-described embodiments.

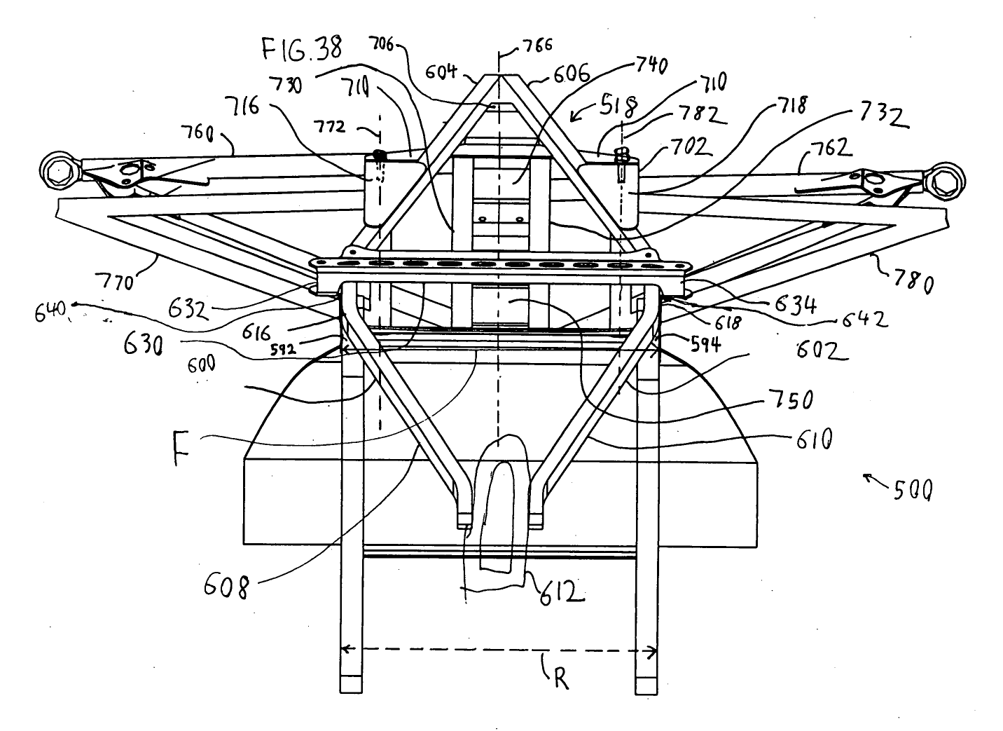

As illustrated in FIGS. 36 and 37, a forward portion 540 of the tunnel 510 is connected to a rearward portion 542. Both portions 540, 542 are preferably made of a sheet metal such as aluminum and are riveted, welded, or otherwise fastened together. Alternatively, the portions 540, 542 may be integrally formed from a single sheet of material. The rearward portion 542 of the tunnel 510 is similar to the rearward portion of the tunnel 86 illustrated in FIG. 11 and described in detail above. However, the forward portion 540 of the tunnel 510 differs from the forward portion of the tunnel 86. While the tunnel 86 of the previous embodiment includes forward side panels that form the lateral sides of an engine compartment, the forward portion 540 of the tunnel 510 does not extend far enough forward to form a part of the engine compartment.

Like the tunnel 86, the forward portion 540 of the tunnel 510 includes openings 546 in the side panels 548 that allow a driveshaft to pass therethrough. As viewed from the side, the forward/upper edges of the side panels 548 generally curve around the openings 546. The forward/upper edges of the side panels 548 are disposed radially outwardly from the openings 546 to provide clearance for an endless drive track that may be mounted around the driveshaft. An apron 550, which is preferably made of a sheet metal, connects between the forward/upper edges of the side panels 548 to provide a barrier between the endless drive track and the engine compartment.

Because the endless drive track must fit within the tunnel 510, the side panels 548 of the forward portion 540 and the side panels of the rearward portion 542 must be spaced apart by a greater distance than the width of the endless drive track used.

Foot rests 560 extend laterally outwardly from the side panels 548 of the forward portion 540 of the tunnel 510. The side panels 548 intersect the foot rests 560 at angles of approximately 90 degrees. The foot rests 560 are preferably integrally formed with the side panels 548. The 90 degree angle is formed by bending the forward portion 540 along longitudinally-extending folding lines.

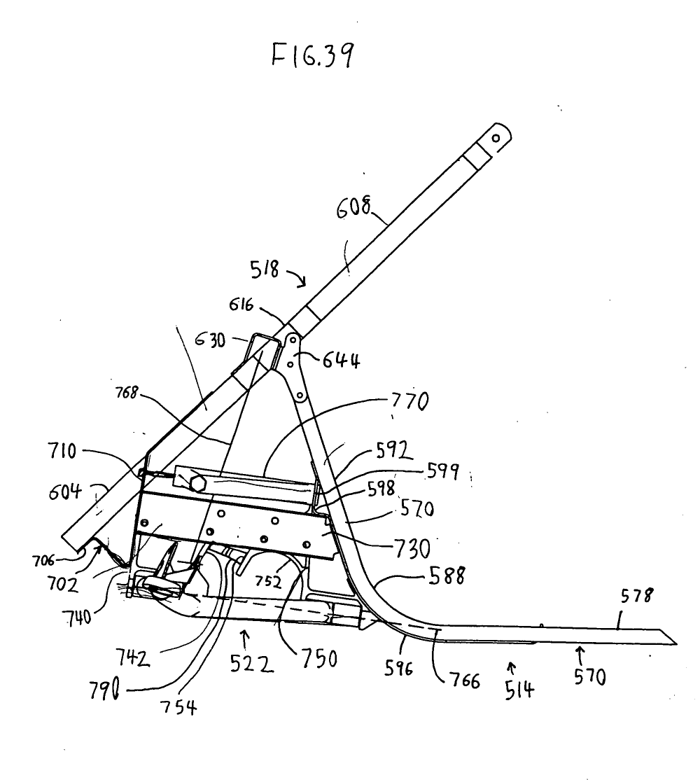

The engine support 514, which connects with the tunnel 510, includes left and right laterally spaced engine support legs 570, 572. Rearward portions 578, 580 of the left and right legs 570, 572, respectively, are parallel to each other and are mounted to the forward portion 540 of the tunnel 510 at the intersections of the side panels 548 and foot rests 560. The engine support legs 570, 572 may be welded, bolted, riveted, or otherwise fastened to the forward portion 540. As illustrated in FIGS. 37 and 38, because the engine support legs 570, 572 are mounted to the outsides of the side panels 548, the engine support legs 570, 572 are necessarily spaced apart by a fixed distance R that is greater than the width of the endless drive track. The fixed distance R is the distance between the laterally-outward surfaces of the rearward portions 578, 580 of the engine support legs 570, 572.

The engine support legs 570, 572 are preferably tubular members that have box-like or square cross-sections. Because the lower surfaces of the rearward portions 578, 580 of the engine support legs 570, 572 are generally level, they abut against the foot rests 560 flushly. Similarly, because the laterally inner surfaces of the rearward portions 578, 580 of the engine support legs 570, 572 extend generally vertically and longitudinally, they abut against the side panels 548 flushly. These flush connections strengthen the joints between the engine support legs 570, 572 and the forward portion 540 of the tunnel 510.

As illustrated in FIGS. 36 and 39, intermediate portions 588, 590 of the engine support legs 570, 572 arc upwardly from the forward ends of the rearward portions 578, 580, respectively. Forward portions 592, 594 of the engine support legs 570, 572 extend upwardly and forwardly from the forward ends of the intermediate portions 588, 590.

A forward engine support plate (or engine cradle plate) 596 connects between the engine support legs 570, 572. As illustrated in FIG. 39, the forward engine support plate 596 preferably comprises sheet metal that is bent to conform to the shape of the lower surfaces of the engine support legs 570, 572. The engine plate 596 is preferably riveted, bolted, or welded to the engine support legs 570, 572. The engine plate 596 extends along the arced intermediate portions 588, 590 of the engine support legs 570, 572 and extends rearwardly, to some extent, along the rearward portions 578, 580 as well. The rearward edge of the engine plate 596 preferably abuts or closely approaches the forward edges of the forward portion 540 of the tunnel 510 and the apron 550 to provide a generally continuous lower barrier between the engine compartment and the area beneath the frame assembly 500.

The engine support plate 596 includes a forward portion 598 that extends forwardly and upwardly from the rest of the engine plate 596 and is located at the forward portions 592, 594 of the engine support legs 570, 572. As best illustrated in FIG. 39, the forward portion 598 of the engine plate 596 progresses upwardly and forwardly with the forward portions 592, 594 of the engine support legs 570, 572. At about midway up the forward portions 592, 594, the forward portion 598 of the engine plate 596 separates from the engine support legs 570, 572 and extends generally forwardly and just slightly upwardly. The engine plate 596 then bends upwardly and progresses generally upwardly and slightly rearwardly to form a generally vertically and laterally extending suspension mounting plate 599. The engine plate 596 thereafter re-engages the forward portions 592, 594 of the engine support legs 570, 572.

FIG. 38 is a partial top view of the forward portion of the frame assembly 500. The forward support assembly 518 includes left and right forward support legs 600, 602. Lower portions 604, 606 of the forward support legs 600, 602 are connected together. Similarly, the upper portions 608, 610 of the forward support legs 600, 602 are connected together by way of their mutual connection to an upper steering bracket 612, which is similar to the steering bracket 374 illustrated in FIG. 28 and described in detail above. Intermediate portions 616, 618 of the forward support legs 600, 602 are laterally spaced from each other such that the forward support legs 600, 602 of the forward support assembly 518 generally forms a diamond shape as viewed from the front and/or top. The forward support legs 600, 602 are preferably tubular members, although any other suitable construction may be used without deviating from the scope of the present invention.

A cross-member 630 connects between the intermediate portions 616, 618 of the forward support legs 600, 602, thereby dividing the diamond shape into upper and lower triangles. The cross member 630 is generally similar to the cross-member 142 illustrated in FIG. 28 and described in greater detail above. Like the cross-member 142, the cross-member 630 includes upper front suspension brackets 632, 634 that extend laterally outwardly from the intermediate portions 616, 618.

As illustrated in FIG. 38, the forward portions 592, 594 of the engine support legs 570, 572 connect to the intermediate portions 616, 618 of the forward support legs 600, 602 at left and right fixed connection points 640, 642. As a result, the left forward portion 592 of the engine support leg 570, the left portion of the cross-member 630, and the left intermediate portion 616 of the left forward support leg 600 all generally connect together at the left connection point 640. Similarly, the right forward portion 594 of the engine support leg 572, the right intermediate portion 618 of the right forward support leg 602, and the right portion of the cross-member 630 all generally connect together at the right connection point 642. As best illustrated in FIG. 39, the cross-member 630 includes left and right mounting brackets 644, 646 that strengthen the connections between the various legs/member at the connection points 640, 642.

The left and right connection points 640, 642 are spaced apart by a lateral distance F. It should be noted that while the connection points 640, 642 are generally defined by the connection points between the various members/legs, for the purpose of measurement, the points 640, 642 shall be defined as the most forward laterally-outward edge of the engine support legs 570, 572. In the embodiment illustrated in FIG. 38, the distances R and F are equal such that the engine support legs 570, 572 are parallel to each other as viewed from above over their entire lengths.

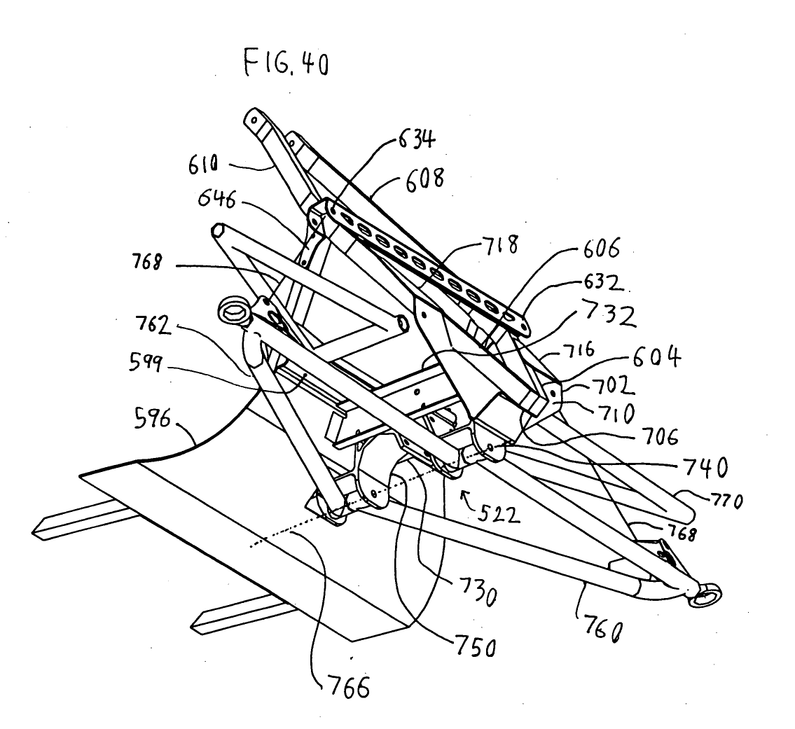

As illustrated in FIG. 39, the suspension arm pivot base assembly 522 connects between the forward support assembly 518 and the engine support 514. The pivot base assembly 522 includes a forward plate 702. The forward plate includes a forward tip 706 that connects to the forward tips of the lower portions 604, 606 of the forward support legs 600, 602. The forward tip 706 functions as a bracket that strengthens the connection between the lower portions 604, 606 of the forward support legs 600, 602. The forward plate 702 extends rearwardly and downwardly from the forward tip 706 and then bends upwardly to define a generally upwardly and slightly rearwardly extending forward suspension mounting plate 710. Where the forward suspension mounting plate 710 intersects the lower portions 604, 606 of the forward support legs 600, 602 as it extends upwardly, the mounting plate 710 extends laterally-outwardly around the legs 600, 602 (see FIGS. 38 and 40). The forward plate 702 bends rearwardly at the upper edge of the forward suspension mounting plate 710 to form left and right upper braces 716, 718 that extend along and are mounted to the forward support legs 600, 602.

The pivot base assembly 522 further includes left and right laterally spaced longitudinal braces 730, 732 that extend generally longitudinally between the forward suspension mounting plate 710 and the mounting plate 599. The forward and rearward ends of the longitudinal braces 730, 732 preferably include flanges that facilitate the connections to the mounting plates 599, 710. The longitudinal braces 730, 732 have a C-shaped cross section to increase their rigidity. However, a variety of other structural members with similarly strong cross-sections could also be used. The longitudinal braces 730, 732 may comprise bent sheet metal or extrusions. The upper rear ends of the longitudinal braces 730, 732 mate with the forward portion 598 of the engine plate 596 where the forward portion bends forwardly away from the engine support legs 570, 572. As a result, the connection between the longitudinal braces 730, 732 and the engine plate 596 is strengthened by the mating contact of multiple surfaces on each brace 730, 732 and the engine plate 596. The intermediate and lower portions 616, 618, 604, 606 of the forward support legs 600, 602, the intermediate and forward portions 588, 590, 592, 594 of the engine support legs 570, 572, and the longitudinal braces 730, 732 of the pivot base assembly generally form triangles when viewed from the side (see FIG. 39).

As illustrated in FIGS. 38-40, a forward lower suspension arm anchor 740 is bolted between the left and right longitudinal braces 730, 732. The forward lower suspension arm anchor 740 is preferably an extruded member that has a generally H-shaped cross-section as viewed from the side (see FIG. 39). The forward vertical portion of the H-shape mates with the mounting plate 710 to strengthen the connection between the forward lower suspension arm anchor 740 and the rest of the pivot base assembly 522. The upper half of the rearward vertical portion 742 of the H-shape of the forward lower suspension arm anchor 740 extends upwardly and rearwardly.

A rearward lower suspension arm anchor 750 includes an upper forward portion 752 that is bolted between the left and right longitudinal braces 730, 732 rearwardly of the forward lower suspension arm anchor 740. A forward end 754 of the upper forward portion 752 extends rearwardly as it extends upwardly so that the forward end 754 is parallel to and longitudinally spaced from the upper half of the rearward vertical portion 742 of the forward lower suspension arm anchor 740. A lower rearward portion of the rearward lower suspension arm anchor 750 is mounted to the engine plate 596.

As illustrated in FIGS. 39 and 40, left and right lower suspension arms (A-arms) 760, 762 are generally V-shaped or U-shaped. The forward tips of the V- or U-shape of the lower suspension arms 760, 762 are each pivotally connected to the forward lower suspension arm anchor 740 for pivotal movement relative to each other and the forward lower suspension arm anchor 740 about a lower suspension arm axis 766. Similarly, the rearward tips of the V- or U-shape of the lower suspension arms 760, 762 are each pivotally connected to the lower rearward portion of the rearward lower suspension arm anchor 750 for pivotal movement relative to each other and the rearward lower suspension arm anchor 750 about the lower suspension arm axis 766. The lower suspension arm axis 766 extends generally longitudinally along the frame assembly 500, is disposed at a lateral centerline of the frame assembly 500, and angles slightly downwardly as it progresses rearwardly. Consequently, the lower suspension arm axis 766 is parallel to and disposed within a vertically and longitudinally extending center plane of the frame assembly 500.

In the illustrated embodiment, the laterally inward tips of the left lower suspension arm 760 are mounted to the suspension arm anchors 740, 750 in front of the corresponding tips of the right lower suspension arm 762. However, the relative axial positions of the tips of the lower suspension arms 760, 762 along the lower suspension arm axis 766 may be altered without departing from the scope of the present invention. Nonetheless, the exact axial position of each tip will dictate the shape of the V- or U-shape of each suspension arm 760, 762 such that the outer ends of the suspension arms 760, 762 are disposed at the same longitudinal position as each other.

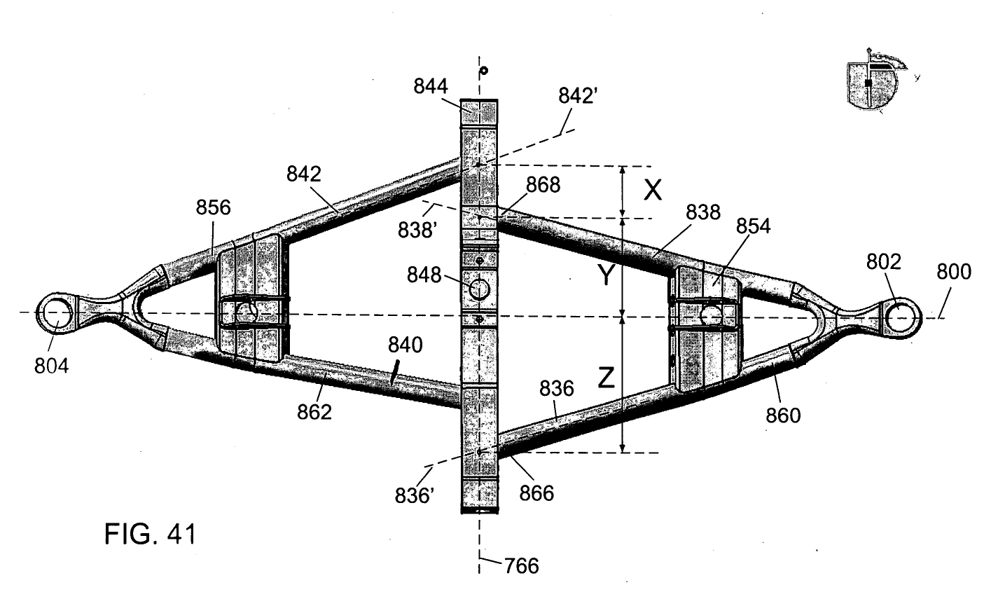

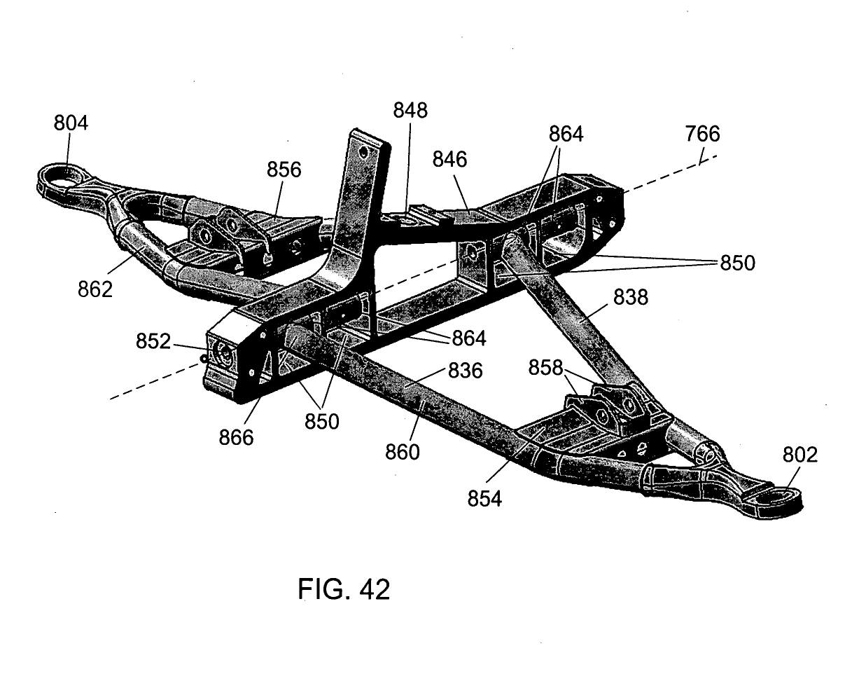

The geometry of the lower suspension arms of one embodiment are shown in FIGS. 41 and 42. Right and left lower suspension arms 860, 862 have a geometry characterized by the equation Z=X+Y as shown in FIG. 41. This geometry enables the right and left suspension arms to be identical and thus has the advantage of reducing the manufacturing cost of the arms. Another advantage of using suspension arms with this geometry is that the eyelets 802, 804 of the opposing identical suspension arms 860, 862 are situated opposite each other along transverse line 800. Having eyelets 802, 804 situated along the same transverse line 800 has one advantage that the skis or the wheels attached to the suspension arms 860, 862 will be aligned when looking at the vehicle from the side or the top. As can been seen from FIG. 41, transverse line 800 is perpendicular to the lower suspension arm axis 766.

Similar to lower suspension arms 220 shown in FIG. 17, lower suspension arms 860 and 862 have front members 836 and 840 respectively and rear member 838 and 842 respectively. Front member 836 and rear member 838 of left lower suspension arm 860 meet at eyelet 802 as can been seen from FIG. 41. Front and rear members 836 and 838 are also connected to bracket 844 along the lower suspension axis 766. Bracket 844 is preferably made of a single piece of material such as aluminum but could also be made as separate parts similar to anchors 740 and 750 shown and described in FIG. 39. Although right and left suspension arms 860 and 862 are given different reference numbers, they are preferably identical to each other. However, right and left suspension arms that are not identical to each other may alternatively be used without deviating from the scope of the present invention.

Bracket 844 includes holes 850 passing laterally through the bracket 844 to accept the lower suspension arms 860 and 862. The bracket 844 also includes a bolt or pin 852 passing along the axis 766 to hold the lower suspension arms 860 and 862 to the Bracket 844 such that the arms 860 and 862 can pivot with respect to the bracket 844 about the axis 766. It is contemplated that one long pin or bolt or two separate pins or bolts could hold both lower suspension arms 860 and 862 to the bracket 844. Bracket 844 further includes a middle portion 846 which includes a hole 848 which accepts a steering shaft (not shown). Bracket 844 is attached to any known vehicle preferably so that the lower suspension axis 766 is disposed within or parallel to a vertically and longitudinally extending center plane of the vehicle.

Lower suspension arms 860 and 862 further include shock absorber attachments 854 and 856. The attachments 854 and 856 are placed along the transverse line 800 between the front and rear members of the lower suspension arms 860 and 862. Shock absorber attachments 854 and 856 further include two vertical plates 858 spaced apart from each other to join the end of the shock absorber 326 (FIG. 22) to the lower suspension arms 860, 862. As seen in FIG. 41, the vertical plates 858 are placed on the attachment 854 such that they are equally distanced from the transverse line 800. This ensures that the shock absorber will remain aligned with the vehicle and also that right and left shock absorbers will be aligned when identical lower suspension arms are opposing each other.

It is preferred that the front and rear members 836 and 838 be made of tubular material such as steel or aluminum but as one skilled in the art would recognize, many cross-sectional shapes and materials can be used.

As mentioned earlier, two suspension arms which are manufactured using the geometry where Z=X+Y as shown in FIG. 41 will, when placed on opposite sides of the suspension arm axis, result in the eyelets of each suspension arm being on the same transverse line which is perpendicular to the suspension arm axis. As can be seen in FIG. 41, Z is the distance from the intersection of the front member 836 (or the axis 836′, which is the longitudinal axis of front member 836) and the suspension arm axis 766 to the transverse axis 800. Rear member 838 has a similar longitudinal axis 838′. Y is the distance between the intersection of the rear member 838 (or the axis 838′) with the suspension arm axis 766 and the transverse axis 800. Similarly, the rear member 842 of the lower suspension arm 862 has an axis 842′, which intersects with suspension arm axis 766. X is the distance between the intersection points of axis 838′ and 842′ with the suspension arm axis 766.

As would understood by one skilled in the art, the distances X, Y, and Z are relied upon to position the right and left lower suspension arms 860 and 862 such that the eyelets 802 and 804 are along the same transverse line. If, for instance, identical lower suspension arms were opposing each other such that X did not equal the difference between Y and Z, then the eyelets would not lie along a common transverse line that is perpendicular to the suspension axis 766. The above geometry is used when the arms are non symmetric about the transverse axis 800 which facilitates the manufacturing of the suspension arms.

As would be appreciated by one skilled in the art, symmetric suspension arms could be manufactured where X=0. This would require the intersections of the front members and the rear members of the right and left lower suspension arms with the suspension arm axis to occur at the same point, if one was to keep the eyelets along the same transverse axis, thus rendering the construction of the suspension arms more complicated but none the less feasable. As can be seen from FIG. 42, the suspension arms 860, 862 are of a simple construction which includes a tubular collar 864 attached, preferably via a weld, to first and second inner ends 866, 868 of the front and rear members 836 and 838 respectively such that the suspension arm can rotate about axis 766. The lower suspension arm 862 also has inner ends each attached to a tubular collar 864. This simple construction facilitates the use of symmetric opposing identical lower suspension arms that keep the eyelets on the same transverse axis.

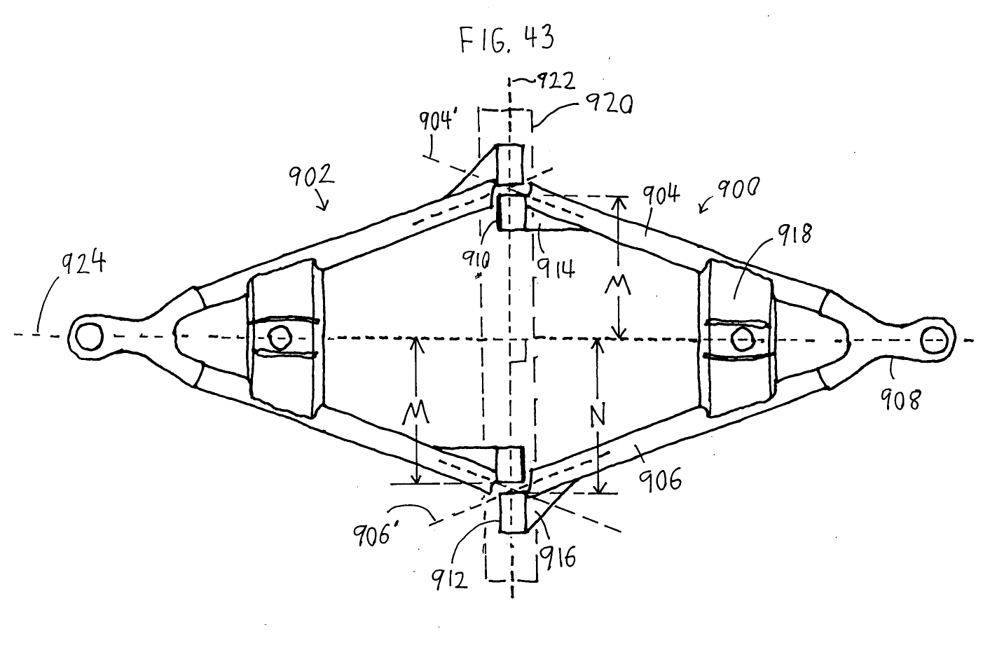

FIG. 43 illustrates an additional alternative embodiment of lower front suspension arms that may be used with a vehicle according to the present invention. The right and left lower suspension arms 900, 902 in this embodiment are similar to the suspension arms 860, 862 illustrated FIGS. 41 and 42. Because the lower suspension arms 900, 902 are identical to each other, only the right lower suspension arm 900 is described in detail. As in the previous embodiment, the suspension arm 900 includes front and back members (or legs) 904, 906 that connect at their outer ends to an eyelet 908. A shock absorber attachment 918 connects between the members 904, 906 to support a shock absorber (not shown).

Inner ends of the front and back members 904, 906 connect to tubular collars 910, 912, respectively. Because the collars 910, 912 are mounted to the members 904, 906 at longitudinal positions that are offset from the axes 904′, 906′ of the members 904, 906, braces 914, 916 are preferably used to strengthen the connection. The collars 910, 912, members 904, 906, and braces 914, 916 maybe welded, glued, bolted, or otherwise fastened to each other.

A bracket 920 (shown in dotted lines) mounts to or is integrally formed with the frame of a vehicle. The collars 910, 912 pivotally connect to the bracket 920 via one or more bolts or pins (not shown) such that the lower right suspension arm 900 pivots relative to the bracket 920 about an axis 922, which is disposed within a vertically and longitudinally extending center plane of the vehicle. The left suspension arm 902 mounts to the bracket 920 in the same way, except that the left suspension arm 902 is rotated 180 degrees relative to the right suspension arm 902 about an axis that extends into FIG. 43. Consequently, when both lower suspension arms 900, 902 are mounted to the bracket 920, the collars 910, 912 of the lower right suspension arm 900 are disposed rearwardly of those of the lower left suspension arm 902 along the axis 922.

The forward longitudinal end of the collar 910 is longitudinally spaced from the axis 924 by a distance M. The forward longitudinal end of the collar 912 is longitudinally spaced from the axis 924 by a distance N. As long as M is smaller than N, identical left and right lower suspension arms may be used without having the collars interfere with each other. Alternative collar positions could also be used without deviating from the scope of the present invention. For example, as would be appreciated by one of ordinary skill in the art, multiple small collars on the front member of the right suspension arm could dovetail with multiple corresponding small collars on the front member of the left suspension arm without interference.

The offset position of the collars 910, 912 relative to the axes 904′, 906′ ensures that the eyelets 908 of the lower suspension arms 900, 902 are disposed along a common transverse axis 924 when both arms 900, 902 mount to the bracket 920. The transverse axis 924 is perpendicular to the longitudinal axis 922.

The offset collar positioning also enables the distance X (as defined in the previous embodiment) to be zero. The lower right and left suspension arms 900, 902 therefore appear to be at the same longitudinal position as each other on the vehicle despite the fact that the collars 910, 912 of the suspension arm 900 are longitudinally offset from those of the collar 902. Symmetrical appearance is thus preserved while still allowing identical right and left lower suspension arms 900, 902 to be used.

Although the suspension arms 860, 862, 900, 902 are all described as lower suspension arms, they may also be used as upper suspension arms of a double A-arm suspension system without deviating from the scope of the present invention. Consequently, the upper left and right suspension arms would pivot relative to the vehicle about a common longitudinal axis in the same way that the lower left and right suspension arms would pivot about a second longitudinal axis.

Left and right ski legs, which are generally identical to the ski legs 208, 210 discussed above and illustrated in FIG. 15, or left and right wheel knuckles, which are generally identical to the wheel knuckles 366, 368 discussed above and illustrated in FIG. 27, are connected to the outer ends of the left and right lower suspension arms 760, 762, respectively, in the same manner as discussed above with respect to the ski legs 208, 210 or wheel knuckles 366, 368. If ski legs are used, skis are operatively attached to the ski legs. If wheel knuckles are used, wheels are operatively attached to the wheel knuckles.

The use of the single lower suspension arm axis 766 for both lower suspension arms 760, 762 results in several advantages over conventional frame assemblies that include laterally offset left and right lower suspension arm axes.

First, because the laterally inward ends of the lower suspension arms 760, 762 both fully extend to the lateral centerline of the frame assembly 500 (as opposed to conventional frame assemblies in which the laterally inward ends of the lower suspension arms are spaced apart and therefore do not extend laterally inward as far), the lower suspension arms 760, 762 of the present invention are longer than the suspension arms of conventional frame assemblies that have the same width. This allows a relatively smaller angular displacement of the lower suspension arms 760, 762 to provide a relatively larger vertical suspension movement of the skis or wheels. As one of ordinary skill in the art would appreciate, the smaller angular displacement of the lower suspension arms 760, 762 relative to conventional lower suspension arms advantageously results in less scrub (lateral ski movement) and less chamber (pivotal movement of the skis/steered devices along their long axis that is generally parallel to the lower suspension axis 766) as the front suspension system of the present invention compresses. The increased suspension arm length also facilitates a larger vertical suspension stroke than in conventional suspension assemblies.

Second, because the lower suspension arms 760, 762 travel over a smaller angular range than conventional frame assemblies for the same vertical suspension displacement range, the ball joints connecting the lower suspension arms 760, 762 to the ski legs or wheel knuckles move less and therefore wear less.

Third, forces acting on either lower suspension arm 760, 762 are transferred to the other lower suspension arm 760, 762 directly at the lower suspension arm axis 766 without having to transfer forces through the rest of the frame assembly 500.

Finally, the lower suspension arms 760, 762 apply torsional force to the frame assembly 500 at the same point on the frame assembly 500 as each other, i.e., the lower suspension arm axis 766. The frame assembly 500 is designed to be very strong along this lower suspension arm axis 766 such that the frame assembly 500 can bear the loads applied to it from the lower suspension arms 760, 762. For example, the connection between the lower portions 604, 606 of the left and right forward support legs 600, 602 forms a vertex that is generally aligned with the lower suspension arm axis 766. The connection of the lower suspension arms to the tubular forward portion of the frame assembly 500 also advantageously reduces the torsional forces that are applied to the tunnel 510.

As schematically illustrated in FIGS. 39 and 40, left and right shock absorbers 768 connect between the left and right upper front suspension brackets 632, 634, respectively, of the cross-member 630 and laterally-outward ends of the lower suspension arms 760, 762, respectively. The shock absorbers 768 and their connections to the frame assembly 500 are generally identical to the shock absorbers 326 and their connection to the frame assembly illustrated in FIG. 14 and described above.

A left upper suspension arm (A-arm) 770 has a generally triangular shape as seen from above (see FIG. 38). As illustrated in FIG. 39, a forward end of the inner leg of the left upper suspension arm 770 is pivotally connected (preferably with a bolt) to an upper left side of the forward suspension mounting plate 710 laterally outwardly from the lower portion 604 of the left forward support leg 600. A rearward end of the inner leg of left upper suspension arm 770 is pivotally connected (preferably with a bolt) to a left side of the mounting plate 599 of the engine cradle plate 596. As a result, the left upper suspension arm 770 pivots relative to the frame assembly 500 about an upper left suspension arm axis 772 that is above and laterally leftward from the lower suspension arm axis 766. A laterally outward end of the left upper suspension arm 770 is connected to the left ski leg or wheel knuckle in the same manner as described above with respect to the previous embodiments.

Similarly, a right upper suspension arm (A-arm) 780 is pivotally connected to the frame assembly 500 between a forward upper right side of the forward suspension mounting plate 710 and the mounting plate 599 of the engine cradle plate 596 for pivotal movement relative to the frame assembly 500 about an upper right suspension arm axis 782 that is above and laterally rightward from the lower suspension arm axis 766. A laterally outward end of the right upper suspension arm 780 is connected to the right ski leg or wheel knuckle in the same manner as described above with respect to the previous embodiments.

As illustrated in FIG. 39, a lower steering shaft bracket 790 is mounted between the rearward vertical portion 742 of the forward lower suspension arm anchor 740 and the forward end 754 of the upper forward portion 752 of the rearward lower suspension arm anchor 750. A steering shaft, which is not shown in this embodiment but is generally similar to the steering shaft 364 described above with respect to the embodiment illustrated in FIGS. 31-34, is pivotally mounted to the upper and lower steering shaft brackets 612, 790 and operatively connected to a steering device such as a handlebar. The lower end of the steering shaft includes a swivel arm that is directly connected to the ski legs via tie rods.

As illustrated in FIGS. 36 and 37, a rear brace assembly 800 connects between the side panels of the rearward portion 542 of the tunnel and the upper steering shaft bracket 612 (or the upper portions 608, 610 of the forward support legs 600, 602). The rear brace assembly 800 includes left and right rear braces 802, 804 that extend upwardly and forwardly from left and right side panels, respectively, of the rearward portion 542 of the tunnel 510. Upper forward ends of the rear braces 802, 804 connect to the upper steering shaft bracket 612. Alternatively, the upper forward ends of the rear braces 802, 804 may connect directly to the upper portions 608, 610 of the forward support legs 600, 602. As a result, the rear braces 802, 804 and the upper portions 608, 610 of the forward support legs 600, 602 generally form a pyramid shape with the upper steering shaft bracket 612 defining the apex of the pyramid. The lower rearward portions of the rear braces 802, 804 bend laterally inwardly such that they are parallel to each other and are flush with the outer side panels of the rearward portion 542 of the runnel. 510. The flush connection strengthens the connection between the rear braces 802, 804 and the tunnel 510. The rear braces 8021, 804 may be welded, bolted, or riveted to the tunnel 510.

Because numerous components of the frame assembly 500 comprise tubular or semi-tubular members, the frame assembly 500 is stronger and more rigid than convention frame assemblies that are substantially formed from weaker sheet material. For example, the forward support legs 600, 602, the rear braces 802, 804, and the engine support legs 570, 572 are preferably extruded tubular members. Similarly, the cross-member 630 and the longitudinal braces 730 are preferably semi-tubular extruded members such as I-beams or C-beams. Alternatively, the cross-member 630 and/or the longitudinal braces 730 may be formed by bending sheet metal into shapes that have strong cross sections (for example, a C-shape). The forward portion 598 of the engine cradle plate 596 is an example of sheet metal that is bent into a stronger shape. The various bends in the forward portion 598 create a strong rigid mounting plate 599 having a multi-directional cross section.

The use of numerous triangles throughout the tubular components of the frame assembly 500 further strengthens the frame assembly 500.

Because of the tubular construction and multiple triangles, the front portion of the frame assembly 500 sustains frontal impacts better than conventional front assemblies that are primarily constructed of sheet metal.

An additional/alternative advantage of the tubular construction of the frame assembly 500 is that the same forward support 518, front suspension pivot base 522, front suspension system, steering system, and engine cradle plate 596 may be used with variously sized tunnels 510 that correspond to endless drive tracks with different widths. The width of the tunnel used depends on the width of the endless track, the tunnel necessarily being wider than the endless drive track. In conventional frame assemblies, the front portion of the frame assembly is sized to match a specific sized tunnel and endless drive track. Accordingly, a front portion of a conventional frame assembly cannot be used with different sized tunnels.

The present invention eliminates the need to have inventories of different sized forward frame assembly portions. Instead, the only portions of the frame assembly 500 that must be changed to accommodate different sized tunnels 510 are the engine support legs 570, 572 and the rear braces 526, 528.

The illustrated tunnel 510 is designed for a narrow endless drive track. If, alternatively, a wider drive track and tunnel are used, the side panels of the tunnel will be spread farther apart. Accordingly, the rear braces (not shown) that replace the illustrated rear braces 802, 804 extend laterally outwardly to a greater extent as the progress downwardly and rearwardly toward the tunnel. However, the forward upper ends of the rear braces are designed to mate with the same upper steering bracket and forward support legs 600, 602 as were used with the narrower tunnel 510.

Similarly, the engine support legs 810, 812 (shown in dotted lines in FIGS. 36 and 37) that are used with the wider tunnel include rearward portions 814, 816 that are wider than the side panels of the wider tunnel. The rearward portions 814, 816 are parallel to each other and spaced apart by a fixed lateral distance R2 that is larger than the distance R between the rearward portions 578, 580 of the engine support legs 570, 572 that are used with the narrower tunnel 510. However, it should be noted that if a tunnel that is narrower that the tunnel 510 is used, the distance R2 would be smaller than the distance R.

The forward portions 818, 820 of the wider engine support legs 810, 812 connect to the forward support legs 600, 602 at the same connection points 640, 642 as in the frame assembly 500 with the narrow tunnel 510. Consequently, the distance F is the same for all frame assemblies, regardless of the size of the tunnel 510.

Intermediate portions 822, 824 of the engine support legs 810, 812 connect between the rearward portions 814, 816 and the forward portions 818, 820. The intermediate portions 822, 824 arc upwardly from the rearward portions 814, 816 to the forward portions 818, 820.

Because the connection points 640, 642 (and consequently the forward ends of the forward portions 818, 820 are spaced apart by the distance F and the rearward portions 814, 816 are spaced apart by a larger distance R2 (see FIG. 37), the engine support legs 810, 812 must angle laterally inwardly between the rearward portions 814, 816 and the forward ends of the forward portions 818, 820 at some point. In the illustrated engine support legs 810, 812, the inward angle occurs entirely at the forward portions 818, 820 (see FIGS. 36 and 37). However, forward ends of the rearward portions 814, 816 or the intermediate portions 822, 824 may alternatively/additionally angle inwardly as they progress forwardly to achieve the same narrowing. Conversely, if a tunnel that is narrower than the tunnel 510 is used, at least one portion of each engine support leg will angle outwardly as it progresses forwardly.

Consequently, the present invention enables different sized tunnels to be used with the same forward support assembly 518, suspension arm pivot base assembly 522, cross-member 630, and engine cradle plate 596 simply by using different engine support legs 600, 602, 810, 812 and different rear braces. By using the same forward portion of the frame assembly for different tunnels, inventory and production costs can be saved.

While the invention has been described by way of example embodiments, it is understood that the words which have been used herein are words of description, rather than words of limitation. Changes may be made, within the purview of the appended claims without departing from the scope and the spirit of the invention in its broader aspects. Although the invention has been described herein with reference to particular structures, materials, and embodiments, it is understood that the invention is not limited to the particulars disclosed.

1-5. (Cancelled)

6. A vehicle comprising:
a frame;
a straddle seat connected to the frame; and
a front suspension assembly, the front suspension assembly comprising:
a right generally triangular shaped lower suspension arm having an inner end and an outer end, the inner end of the right lower suspension arm being connected to the frame for pivotal movement relative to the frame about a lower suspension axis;
a left generally triangular shaped lower suspension arm having an inner end and an outer end, the inner end of the left lower suspension arm being connected to the frame for pivotal movement relative to the frame about the lower suspension axis;
one of a right ski and a right wheel connected to the outer end of the right lower suspension arm such that the one of a riaht ski and a right wheel rotates about a first axis of rotation to steer the vehicle; and
one of a left ski and a left wheel connected to the outer end of the left lower suspension arm such that the one of a left ski and a left wheel rotates about a second axis of rotation to steer the vehicle.
wherein a transverse line intersecting the first axis of rotation and the second axis of rotation is perpendicular to the lower suspension axis.

7. A vehicle according to claim 6, further comprising:
a right generally triangular shaped upper suspension arm having an inner end connected to the frame for pivotal movement relative to the frame about a first upper suspension axis and an outer end connected to the one of the right ski and the right wheel; and
a left generally triangular shaped upper suspension arm having an inner end connected to the frame for pivotal movement relative to the frame about a second upper suspension axis and an outer end connected to the one of the left ski and the left wheel.

8. A vehicle according to claim 6, wherein the inner end of the right lower suspension arm further includes first and second inner ends, the first and second inner ends being connected to the frame for pivotal movement relative to the frame about the lower suspension axis; and
wherein the inner end of the left lower suspension arm further includes first and second inner ends, the first and second inner ends being connected to the frame for pivotal movement relative to the frame about the lower suspension axis.

9. A vehicle according to claim 6, wherein the lower suspension axis lies within a vertical and longitudinally extending center plane of the vehicle.

10. A vehicle according to claim 6, wherein the frame further comprises:
a tunnel;
an engine supported by the frame; and
an endless drive track below the tunnel and operatively connected to the engine to propel the frame assembly,
wherein the one of the right ski and the right wheel comprises a right ski, and
wherein the one of the left ski and the left wheel comprises a left ski.

11. A vehicle according to claim 6, further comprising:
an engine supported by the frame; and
at least one rear wheel operatively connected to the engine to propel the frame assembly,
wherein the one of the right ski and the right wheel comprises a right wheel, and
wherein the one of the left ski and the left wheel comprises a left wheel.

12. A vehicle according to claim 8, wherein the first and second inner ends of the right lower suspension arm each include a joint, the joints pivotally connect the right lower suspension arm to the frame along the lower suspension axis; and
wherein the first and second inner ends of the left lower A-arm each include a joint, the joints pivotally connect the left lower A-arm to the frame along the lower suspension axis, the joints of the first and second inner ends of the right lower A-arm being longitudinally offset from the joints of the first and second inner ends of the left lower A-arm.

13. A vehicle according to claim 6 wherein the lower right suspension arm is identical to the lower left suspension arm.

14. A vehicle according to claim 13 wherein the right lower A-arm further includes a first eyelet, the left lower A-arm further includes a second eyelet, the first eyelet and the second eyelet being positioned along the transverse line.

15. A vehicle according to claim 12, wherein at least one of the joints of the inner ends of the right lower suspension arm Is situated between the joints of the inner ends of the left lower suspension arm.

16. A vehicle according to claim 12, wherein at least one of the joints of the inner ends of the left lower suspension arm is situated between the joints of the inner ends of the right lower suspension arm.

17. A vehicle comprising:
a frame;
a straddle seat connected to the frame; and
a front suspension assembly, the front suspension assembly comprising:
a right lower suspension arm having a front member and a rear member, the members having a common attachment point at outer ends thereof such that the right lower suspension arm is substantially triangular shaped when viewed from above, each of the members pivotally connected along a lower suspension axis to the chassis at inner ends thereof, and each of the members connected to one of a right ski and a right wheel at their outer ends such that the one of a right ski and a right wheel rotate about a first axis of rotation; and
a left lower suspension arm having a front member and a rear member, the members having a common attachment point at outer ends thereof such that the left lower suspension arm is substantially triangular shaped when viewed from above, each of the members pivotally connected along the lower suspension axis to the chassis at Inner ends thereof, and each of the members connected to one of a left ski and a left wheel at their outer ends such that the one of a left ski and a left wheel rotate about a second axis of rotation,
wherein a transverse line intersecting the first axis of rotation and the second axis of rotation is perpendicular to the lower suspension axis.

18. The vehicle as claimed in claim 17, wherein the right lower suspension arm is identical to the left lower suspension arms.
